(19) United States
(12) Patent Application Publication
(10) Pub. No.: US 2008/0172917 A1
(43) Pub. Date: Jul. 24, 2008

(54) Sign Display System and Method

(76) Inventors: Tim Brandow, Mound, MN (US); Kay Musech, Mound, MN (US)

Correspondence Address: MERCHANT & GOULD PC, P.O. BOX 2903, MINNEAPOLIS, MN, 55402-0903, US

(21) Appl. No.: 11/874,079

(22) Filed: Oct. 17, 2007

Related U.S. Application Data
(60) Provisional application No. 60/829,827, filed on Oct. 17, 2006.
(60) Provisional application No. 60/947,330, filed on Jun. 29, 2007.

(51) Int. Cl. G09F 15/00

(52) U.S. Cl. 40/606.14; 40/606.01; 40/606.16

(57) ABSTRACT

A sign display system arranged for connection to a product display system having vertically oriented upright supports, the upright supports including a face arranged in a vertical plane and having a plurality of slots formed therein. The sign display system includes first and second mounting brackets, first and second extension arms, and a sign support assembly. The first and second mounting brackets each include at least one tab insertable within the slots at connection points. The first and second extension arms each have a first end and a second end, the first end connected to the respective first or second mounting bracket and the second end extending away from the mounting bracket at an angle. The sign support assembly is configured to support a sign, the sign support assembly is supported by the first and second extension arms and has a top side and a bottom side. The bottom side of the sign support assembly is supported vertically above the connection point.

### CROSS-REFERENCE TO RELATED APPLICATIONS

This application claims priority to U.S. Provisional Application No. 60/829,827 filed on Oct. 17, 2007, entitled SIGN DISPLAY SYSTEM AND METHOD, and to U.S. Provisional Application No. 60/947,330 filed on Jun. 29, 2007, entitled ELEVATED DISPLAY SYSTEM AND MOUNTING ADAPTER, the disclosures of which are incorporated by reference herein in their entirety.

### TECHNICAL FIELD

This disclosure relates to sign display systems and methods of manufacturing the same.

### BACKGROUND

An important part of most retail businesses is the way in which products are displayed. A product display system often includes shelving on which various products can be placed to be prominently displayed to customers. One product display system is made by Lozier Corporation of Omaha, Nebr. This system includes a vertical back panel disposed between two upright supports that extend vertically from the floor to the top of the back panel. The upright supports include a face including a plurality of uniformly spaced slots. The horizontal shelves include a front, two sides, and a back. Extending from the rear of each side are two or more tabs spaced apart from each other approximately equal to the spacing of the slots in the upright supports. The shelves are mounted by inserting the tabs into the slots in each of the upright supports.

In addition to product display shelving, it is often desirable to provide decorative or informational displays such as signs or banners in close proximity to the products that are being displayed. The canopy is mounted to the product display system in an orientation that takes the place of or would obscure a shelf mounted near the top end of the upright supports. As a result, a shelf cannot be placed near to the top of the display system.

### SUMMARY OF THE DISCLOSURE

The present disclosure relates generally to product display systems, and more specifically to elevated sign display systems. In one example, a sign display system includes a pair of extension arms. The extension arms each connect at one end to the respective upright support of a product display system. In one arrangement, the extension arms include a vertical portion and a horizontal portion. In another arrangement the extension arms include a portion that extends at an angle (e.g., 45 degree angle) relative to a vertical plane. In other example, a sign display system can include adjustable features that provide adjustment of at least one of a width, height, or depth of the sign display system.

The above summary is not intended to describe each disclosed embodiment or every implementation of the inventive aspects disclosed herein. Figures in the detailed description that follow more particularly describe features that are examples of how certain inventive aspects may be practiced. While certain embodiments are illustrated and described, it will be appreciated that disclosure is not limited to such embodiments.

### BRIEF DESCRIPTION OF THE DRAWINGS

FIG. 1 is a front perspective view of an example product display system including an elevated sign display system.

FIG. 2 is a rear perspective view of the sign display system shown in FIG. 1.

FIG. 3 is a front perspective view of the sign display system shown in FIG. 1 not including the brackets for connection with the upright supports.

FIG. 4 is a top view of the sign display system shown in FIG. 1.

FIG. 5 is a side view of the sign display system shown in FIG. 1.

FIG. 6 is a front view of the sign display system shown in FIG. 1.

FIG. 7 is a side view of the extension arm shown in FIG. 1.

FIG. 8 is a top view of the extension arm shown in FIG. 1.

FIG. 9 is a perspective view of an example upright bracket for connection to a Lozier display system.

FIG. 10 is a front view of the upright bracket shown in FIG. 9.

FIG. 11 is a top view of the upright bracket shown in FIG. 9.

FIG. 12 is a side view of the upright bracket shown in FIG. 9.

FIG. 13 is a perspective view of a rear portion of the upright bracket shown in FIG. 9.

FIG. 14 is a front view of the rear portion shown in FIG. 13.

FIG. 15 is a side view of the rear portion shown in FIG. 13.

FIG. 16 is a top view of the rear portion shown in FIG. 13.

FIG. 17 is a perspective view of the arm support member of the upright bracket shown in FIG. 9.

FIG. 18 is a side view of the arm support member shown in FIG. 17.

FIG. 19 is a perspective view of one example of an upright bracket designed for connection to a Hussmann Corporation of Bridgeton, Mo. brand display system.

FIG. 20 is a front view of the upright bracket shown in FIG. 19.

FIG. 21 is a top view of the upright bracket shown in FIG. 19.

FIG. 22 is a side view of the upright bracket shown in FIG. 19.

FIG. 23 is a perspective view of a rear portion of the upright bracket shown in FIG. 20.

FIG. 24 is a front view of the rear portion shown in FIG. 23.

FIG. 25 is a side view of the rear portion shown in FIG. 23.

FIG. 26 is a top view of the rear portion shown in FIG. 23.

FIG. 27 is a perspective view of an arm support member of the upright bracket shown in FIG. 19.

FIG. 28 is a side view of the arm support member shown in FIG. 27.

FIG. 29 is a side view of another example upright bracket.

FIG. 30 is an alternate side view of the upright bracket shown in FIG. 29.

FIG. 31 is a front view of the upright bracket shown in FIG. 29.

FIG. 32 is a perspective view of a stand-alone sign display.

FIG. 33 is a perspective view of the stand-up bracket shown in FIG. 32.

FIG. 34 is a perspective view of a peg-hole sign display.

FIG. 35 is a perspective view of a hanging sign display.

FIG. 36 is a perspective view of a side hanging sign display.

FIG. 37 is a perspective view of an edge connecting sign display.

FIG. 38 is a front perspective view of an example product display system including an elevated sign display system in accordance with principles of the present disclosure.

FIG. 39 is an exploded front perspective view of the system shown in FIG. 38.

FIG. 40 is a perspective view illustrating upright bracket portions of the sign display system shown in FIG. 38 being installed to the product display system.

FIG. 41 is a first side view of the upright bracket shown in FIG. 40.

FIG. 42 is a front view of the upright bracket shown in FIG. 40.

FIG. 43 is a second side view of the upright bracket shown in FIG. 40.

FIG. 44 is a side view of an extension arm portion of the sign display system shown in FIG. 38.

FIG. 45 is a perspective view of a spring button feature of the sign display system shown in FIG. 38.

FIG. 46 is a perspective view of an upright support extension adapted for use with the sign display system and product display system shown in FIG. 38.

FIG. 47 is a front view of the upright support extension shown in FIG. 46.

FIG. 48 is a side view of the upright support extension shown in FIG. 46.

FIG. 49 is a side view of a portion of the upright support extension shown in FIG. 46.

FIG. 50 is a front view of the portion of the upright support extension shown in FIG. 49.

FIG. 51 is a perspective view illustrating an adjustable frame portion of the sign display system shown in FIG. 38 being installed to the product display system.

FIG. 52 is a top view of the adjustable frame portion shown in FIG. 51.

FIG. 53 is a side view of the adjustable frame portion shown in FIG. 51.

FIG. 54 is a perspective view of a frame assembly portion of the sign display system shown in FIG. 38 being installed to the product display system.

FIG. 55 is a front view of the frame assembly portion shown in FIG. 54.

FIG. 56 is a side view of the frame assembly portion shown in FIG. 54.

FIG. 57 is a top view of the frame assembly portion shown in FIG. 54.

FIG. 58 is a perspective view of a side panel portion of the sign display system shown in FIG. 38 being installed to the product display system.

FIG. 59 is a side view of the side panel portion shown in FIG. 58.

FIG. 60 is a partial close up perspective view of a corner portion of the sign display system shown in FIG. 38 with the door in an opened position.

FIG. 61 is a side view of a hinge member of the sign display system shown in FIG. 60.

FIG. 62 is a top view of the hinge member shown in FIG. 61.

FIG. 63 is a perspective view of the door shown in FIG. 60.

### DETAILED DESCRIPTION

A shortcoming with some types of product display systems is that if a sign is added, the sign reduces the storage or display capacity. For example, if a sign is inserted in place of an upper shelf, the shelf is no longer available for storage or display of a product. Even if the sign can be placed slightly above the shelf, the sign may obscure or block a portion of the product display system, such that the effective capacity of the product display system is reduced.

Some examples disclosed herein overcome these disadvantages by providing a sign display system that elevates a sign. The elevation of the sign positions the sign in a more desirable location, such as to provide increased storage or display capacity of the product display system. In addition, some examples are arranged such that the sign is positioned forward from upright supports, such as to place the sign in closer proximity to a customer. Examples of the product display system are adjustable in several dimensions. Some arrangements allow for sign height adjustment, adjustment of the forward position of the sign, and adjustment for varying sign widths.

Further, some examples of the sign display system include interchangeable parts. This is advantageous, for example, to allow the sign display system to be connected to different types of product display systems, by simply interchanging the mounting brackets. As a result, examples of sign display system are adjustable for use in various configurations.

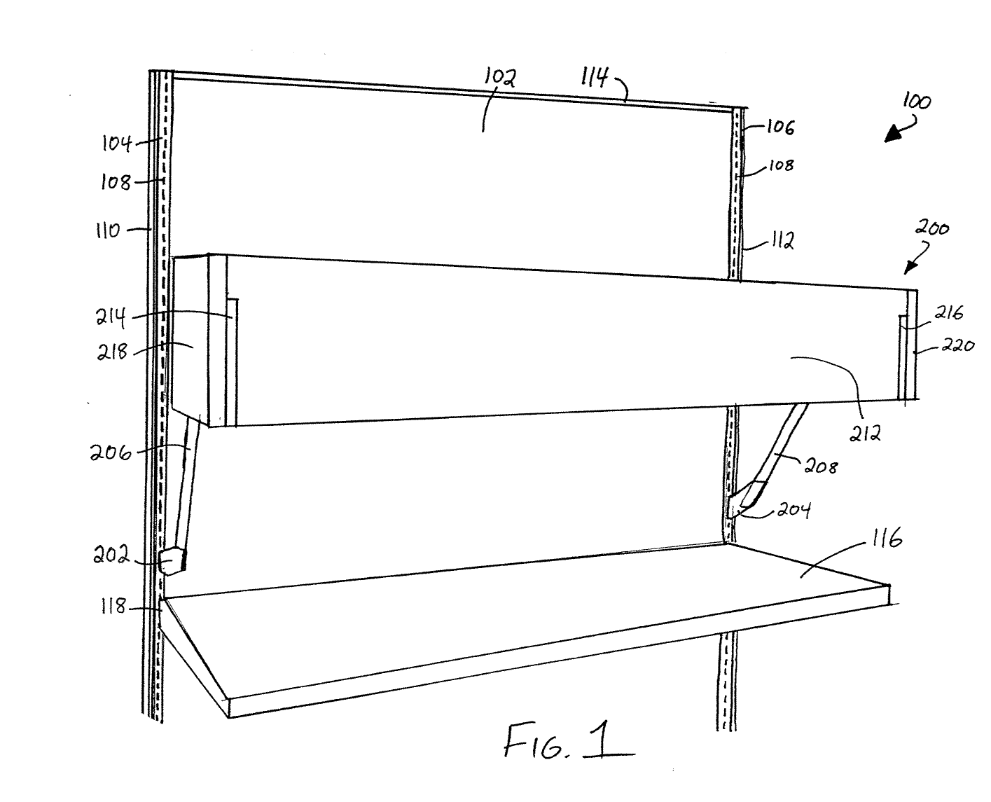

FIG. 1 is a perspective view of product display system 100 and attached elevated sign display 200. Product display system 100 is an example of a typical existing system used for the display of products, such as in a retail store. Product display system 100 includes a vertical back panel 102 disposed between two vertically extending upright supports 104 and 106. A face of each of the upright supports 104 and 106 includes a plurality of uniformly spaced slots 108. A side of each of the upright supports 104 and 106 opposite back panel 102 may be covered with upright end trim 110 and 112 to provide a finished look to the outer sides of product display system 100. In addition, a top rail 114 is disposed above back panel 102 and between upright supports 104 and 106. Shelves such as shelf 116 are attached to product display system 100 by inserting tabs 118 located on the rear of each side of shelf 116 into slots 108 of upright support 104 and 106. Shelves 116 include a horizontal surface for the placement of products or anything else that is to be displayed. Shelves 116 are optional.

Elevated sign display system 200 can be connected to product display system 100. Elevated sign display system 200 can, for example, display information pertaining to a product or display a decorative sign to improve the appearance of product display system 100. Elevated sign display system 200 may display relevant information pertaining to the product, such as the name of the product, the name of the manufacturer, a special price of the product, or information explaining why the customer may desire to purchase the product. In addition, elevated sign display system 200 may include pictures or designs intended to draw the customer's attention to the product or to improve the aesthetic appearance of the display.

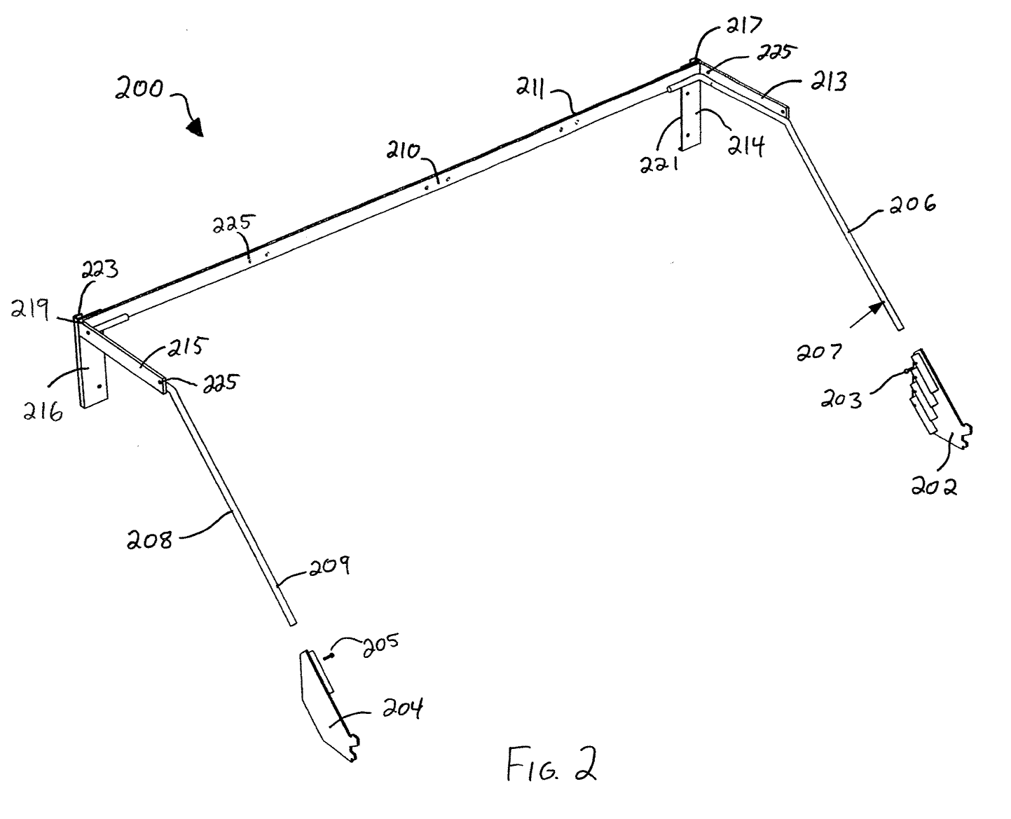

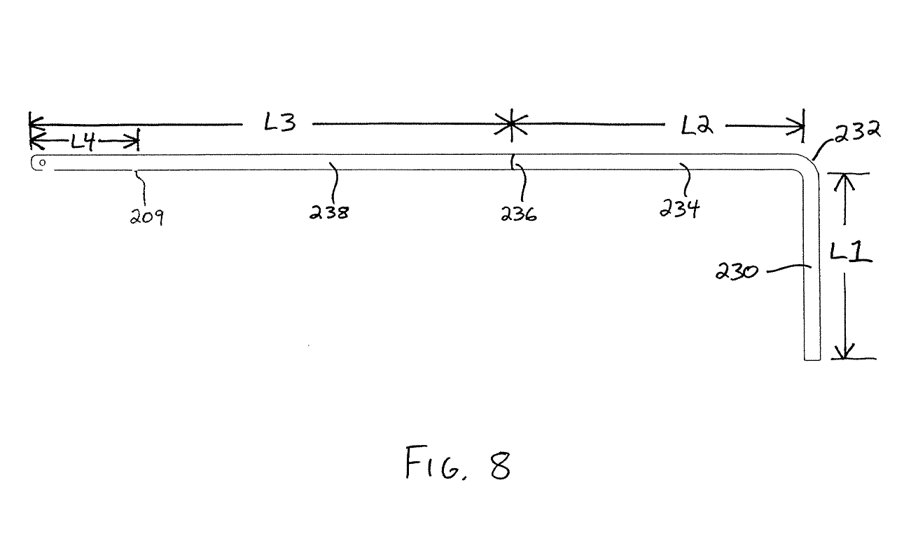

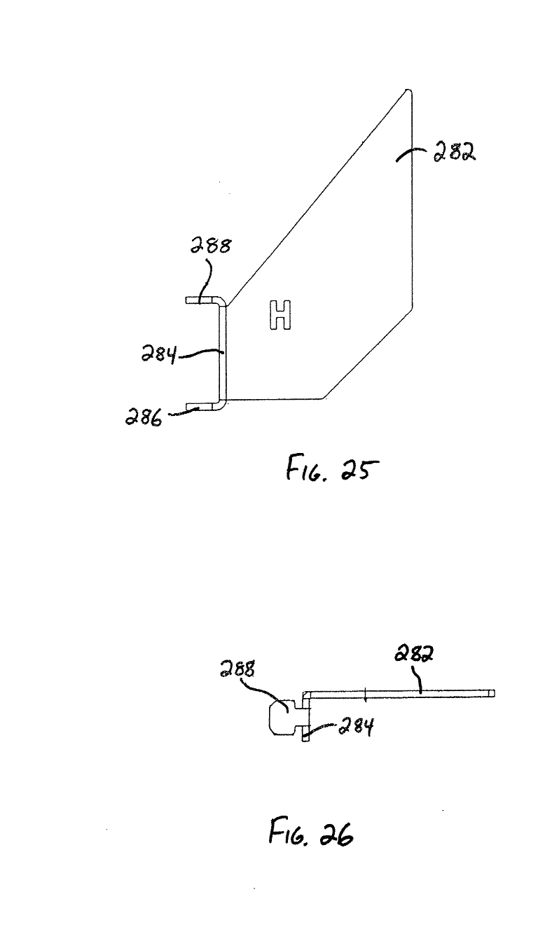

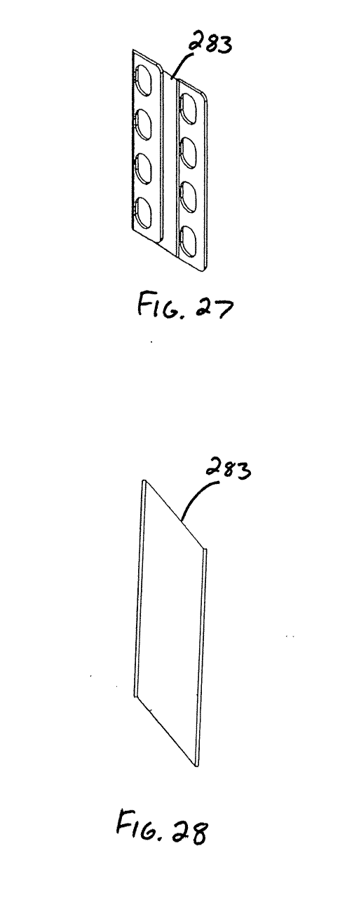

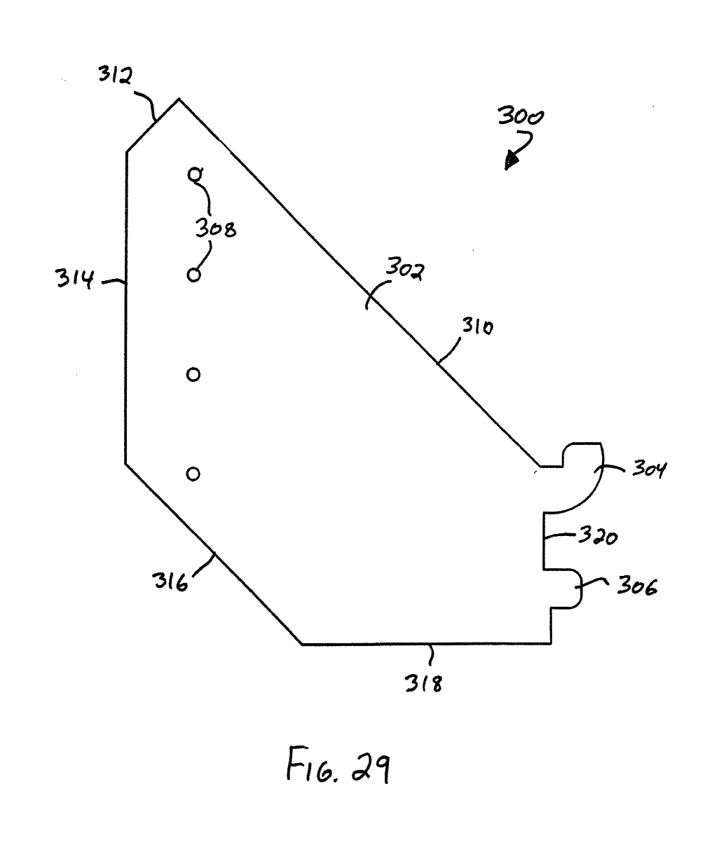

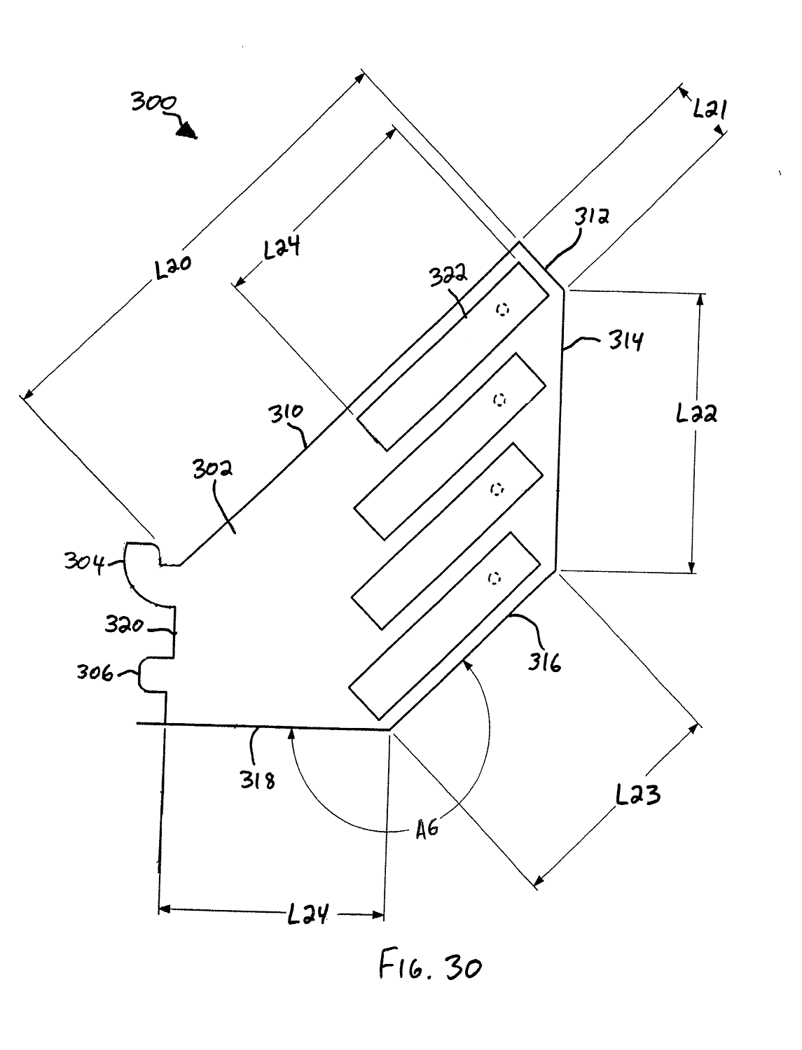

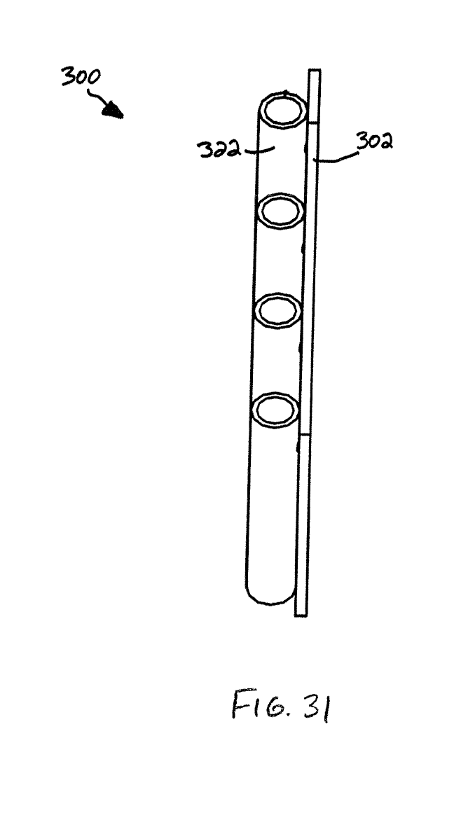

Sign display system 200 includes upright brackets 202 and 204, extension arms 206 and 208, horizontal support beam (e.g., horizontal support beam 210 shown in FIG. 2), sign 212, side retaining members 214 and 216, and side plates 218 and 220. Upright brackets 202 and 204 connect to and support extension arms 206 and 208. Upright brackets 202 and 204 are designed to connect with upright supports 104 and 106 of product display system 100. Upright brackets 202 and 204 are described in more detail with reference to FIGS. 9-31. Extension arms 206 and 208 extend up from upright bracket 202 and 204 and angle away from upright supports 104 and 106. Sign display system 200 also includes a sign support assembly. In this example, the sign support assembly includes a horizontal support beam 210, and side plates 218 and 220. Horizontal support beam 210 (see FIG. 2), located behind sign 212 and side plates 218 and 220, extends between and connects to the ends of extension arms 206 and 208 opposite upright brackets 202 and 204. Side retaining members 214 and 216 are connected to an outer side of horizontal support beam 210, each containing a channel to hold one side of sign 210 in place. Side plates 218 and 220 are included on either side of sign display system 200 and connected to the sides of the horizontal support beam.

FIG. 2 is another perspective view of sign display system 200 including upright brackets 202 and 204, extension arms 206 and 208, horizontal support beam 210, and side retaining member 214 and 216. Upright brackets 202 and 204 include fastener 203 and 205, such as screws, that can be used to fasten one end of each of extension arms 206 and 208 to upright brackets 202 and 204, respectively. Holes 207 and 209 in one end of each of extension arms 206 and 208 are provided for the insertion of fasteners 203 and 205. It is recognized that any other fasteners could also be used to connect upright brackets 202 and 204 to extension arms 206 and 208, respectively.

Horizontal support beam 210 is connected to an opposite end of extension arms 206 and 208 from upright brackets 202 and 204. Horizontal support beam 210 is a generally elongated “u-shaped” member having face 211 and sides 213 and 215. At each end of face 211, sides 213 and 215 adjoin face 211 at corners 217 and 219. Side retaining member 214 and 216 extend generally downward from face 211 adjacent corners 217 and 219, respectively. Side retaining members 214 and 216 include channels 221 and 223 for holding a sign (e.g., sign 210 shown in FIG. 1). Holes 225 are formed in faces 211 and side 213 and 215 for fastening sign 212 or side plates 218 and 220.

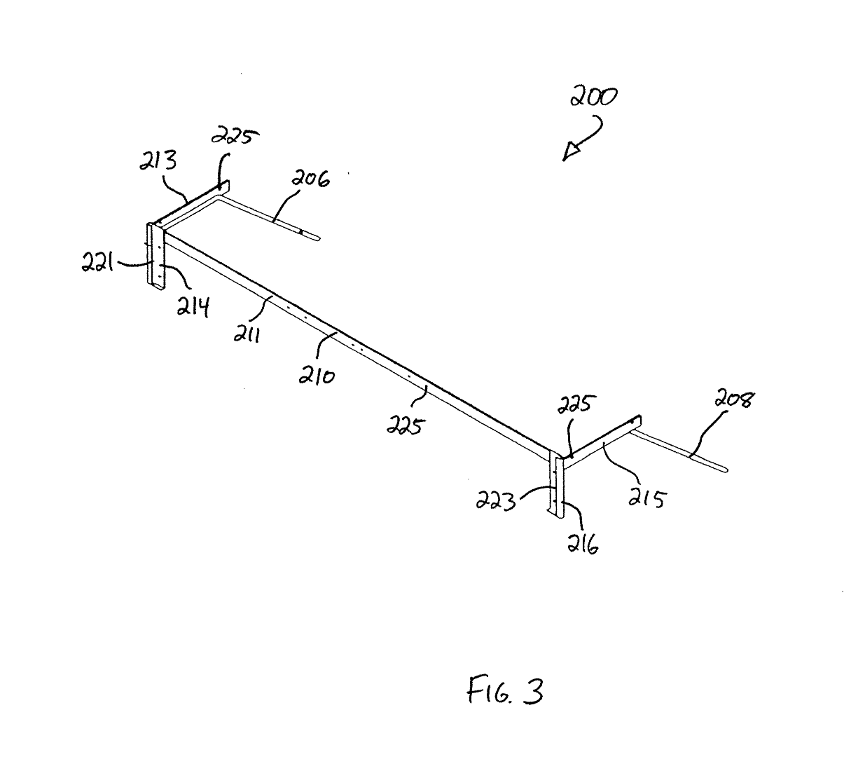

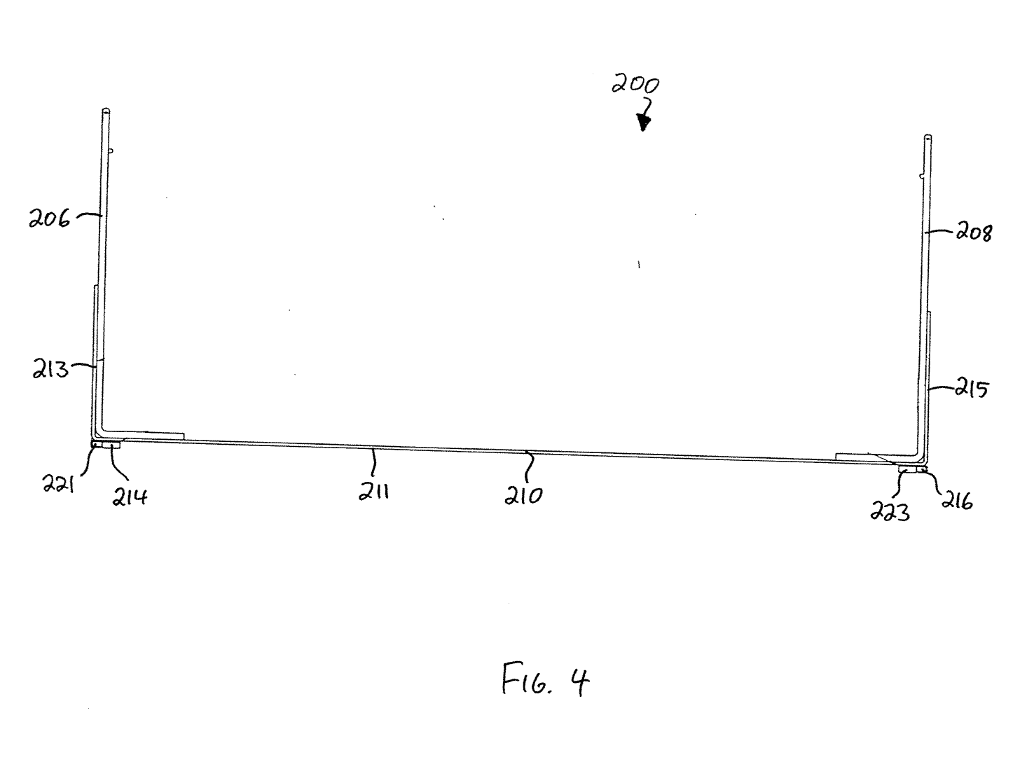

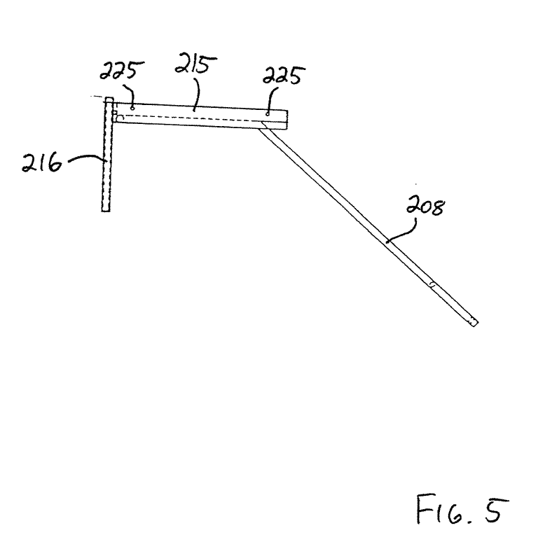

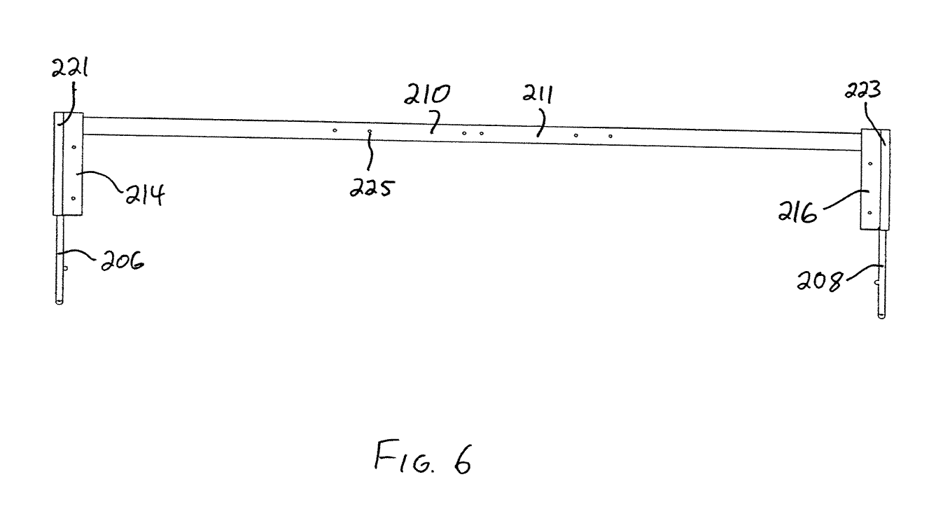

FIGS. 3-6 illustrate alternate views of sign display system 200 including a front perspective view (FIG. 3), a top view (FIG. 4), a side view (FIG. 5), and a front view (FIG. 6). Note that upright brackets 202 and 204 are not shown in FIGS. 3-6.

Sign display 200 can be made out of any suitable material, including steel, aluminum, other metals or metal alloys, polymers such as plastics, wood, composites or any other desired material. Preferably, sign display 200 is made from powder-coated steel.

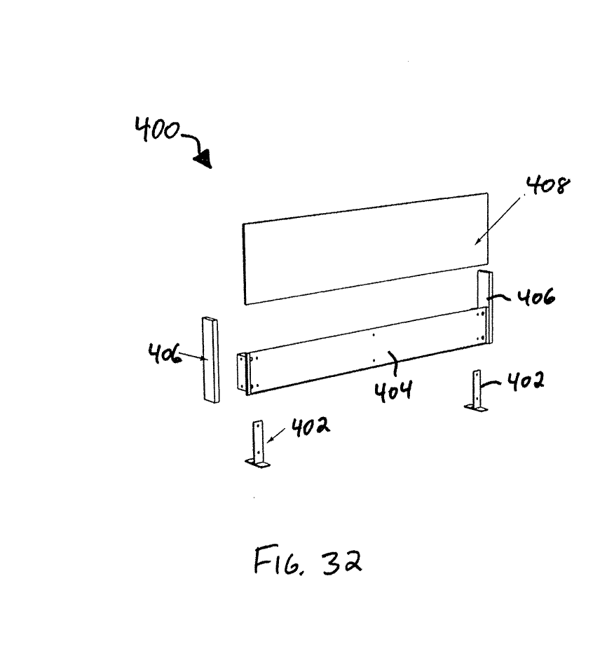

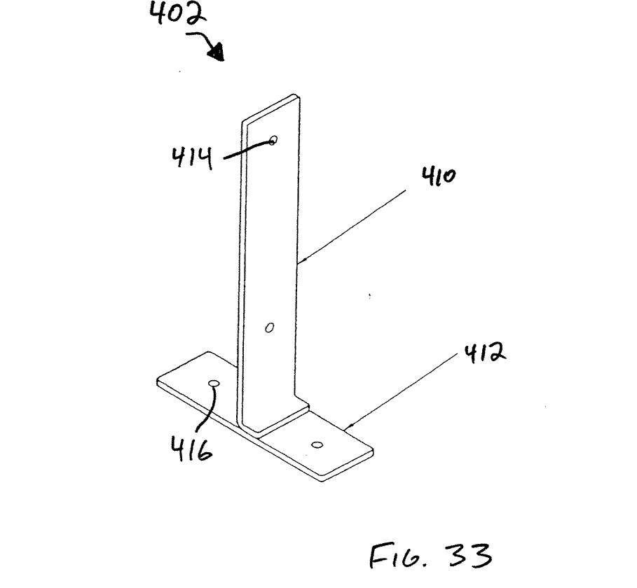

An advantage of some embodiments of sign display system 200 is that it is customizable to the user's specific desires and shelving systems. For example, sign display system 200 can be used with any type of shelving system (e.g. Lozier, Hussmann, or any other brand or style of shelving system) by substituting the appropriate upright bracket (e.g. 202 and 204) for connection with that type of shelving system. If no connection is possible, alternate mounting methods such as those illustrated in FIGS. 32-37 may also be used. The remainder of sign display system 200 need not be modified to adapt to the desired shelving system. Sign display system 200 is also light weight because of the minimal frame design used to support sign 212. The design of side retaining members (e.g. 214 and 216) enable sign 212 to be easily changed, as is frequently required in the retail environment.

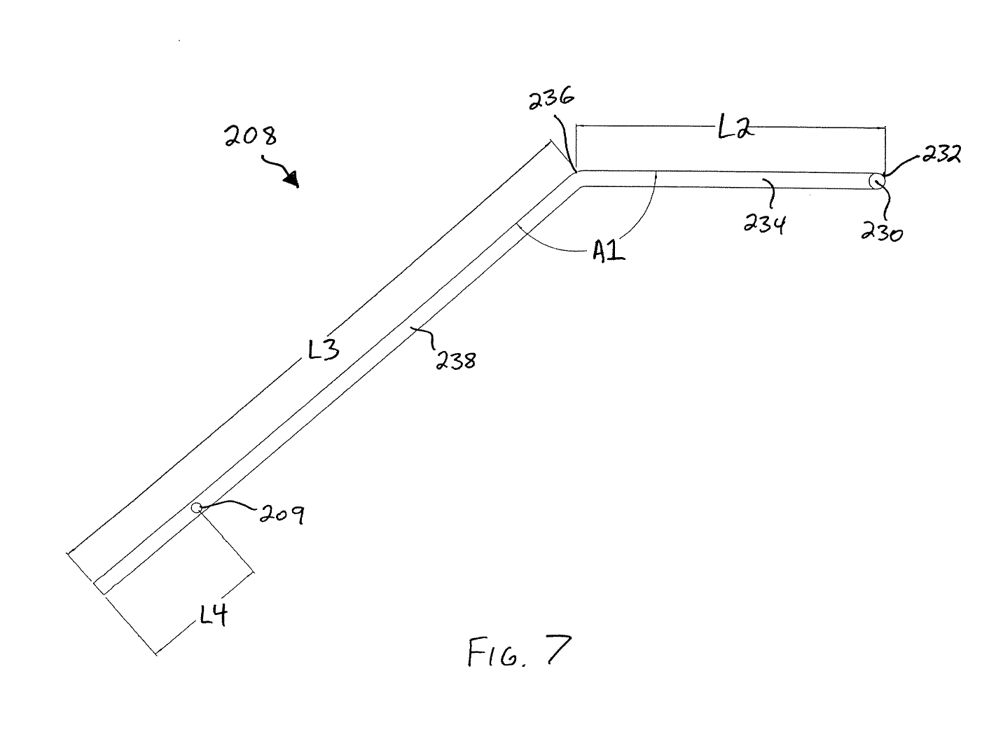

Extension arms 206 and 208 will now be described with reference to extension arm 208 with reference to FIGS. 7-8. To simplify the following discussion, extension arm 206 will not be independently described because it is the mirror image of extension arm 208.

Extension arm 208 includes face member 230, corner 232, side member 234, corner 236, and rear member 238. Rear member 238 includes hole 209.

Extension arm 208 can be formed, for example, from a straight rod. The rod is first cut to length, and then bent at corners 232 and 236. Corner 232 is roughly a 90 degrees angle between face member 230 and side member 234. A bend is also made at corner 236 forming angle A1 between side member 234 and rear member 238. Angle A1 is typically in a range from about 90 degrees to about 180 degrees, and preferably from about 120 degrees to about 160 degrees.

Rough dimensions will now be provided for one example of arm 208. Face member 230 has length L1 that is typically in a range from about 3 inch to about 10 inches, and preferably from about 4 inches to about 6 inches. Side member 234 has length L2 that is typically in a range from about 3 inches to about 24 inches, and preferably from about 6 inches to about 12 inches. Rear member 238 has a length L3 that is typically in a range from about 10 inches to about 36 inches and preferably from about 14 inches to about 20 inches. Hole 209 is formed a distance L4 from an end of rear member 238 opposite corner 236. Length L4 is typically in a range from about 1 inch to about 5 inches, and preferably from about 2 inches to about 4 inches.

FIGS. 9-18 illustrate one example of upright brackets that are connectable to a Lozier product display system. Upright bracket 240 includes rear portion 242 and arm support member 244.

FIG. 9 is a perspective view of upright bracket 240 for use on one side of sign display system 200. It is recognized that a mirror image upright bracket would also be used on the other side of sign display system 200 in some embodiments.

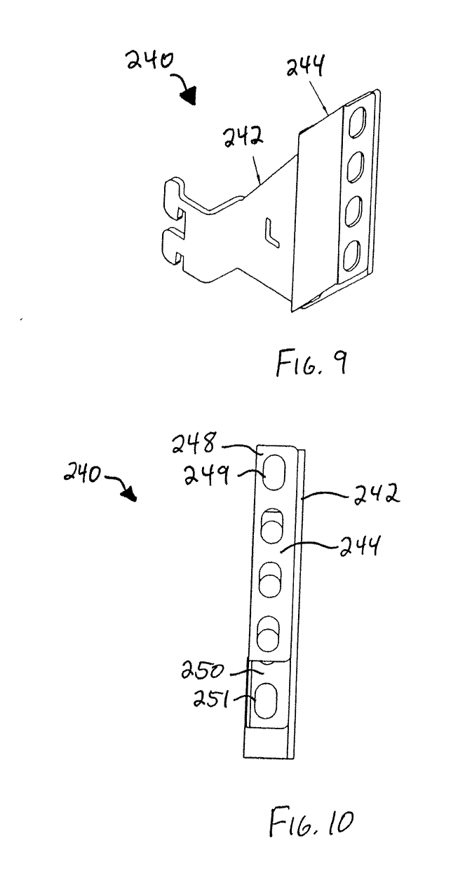

FIG. 10 is a front view of upright bracket 240 including rear portion 242 and arm support member 244. Rear portion 242 and arm support member 214 may be fastened together by any type of fastener including welding, glue, screws or any other desired method. Arm support member 244 includes face plate 248 having a plurality of holes 249, rear plate 250 having a plurality of holes 251, and side plate 253. Side plate 253 connects to one side of each of face plate 248 and rear plate 250, the side being opposite rear portion 242. Holes 249 and 251 are shaped and designed to receive one end of extension arm 208. For example, to assemble extension arm 208 with upright bracket 240, one end of extension arms 206 and 208 is inserted into hole 249 in face panel 248 and then slid through hole 249 until the end of extension arm 208 is inserted through hole 251 in rear panel 250.

Extension arm 208 is secured to upright bracket 240 by any type of fastener (e.g., screws or bolts) or frictional contact. In addition, a pin may be inserted in a hole (e.g., hole 209) that extends perpendicular to extension arm 208. When extension arm 208 is inserted into upright bracket 240, the pin will stop the insertion at the appropriate location and inhibit any further movement of extension arm 208 through upright bracket 240.

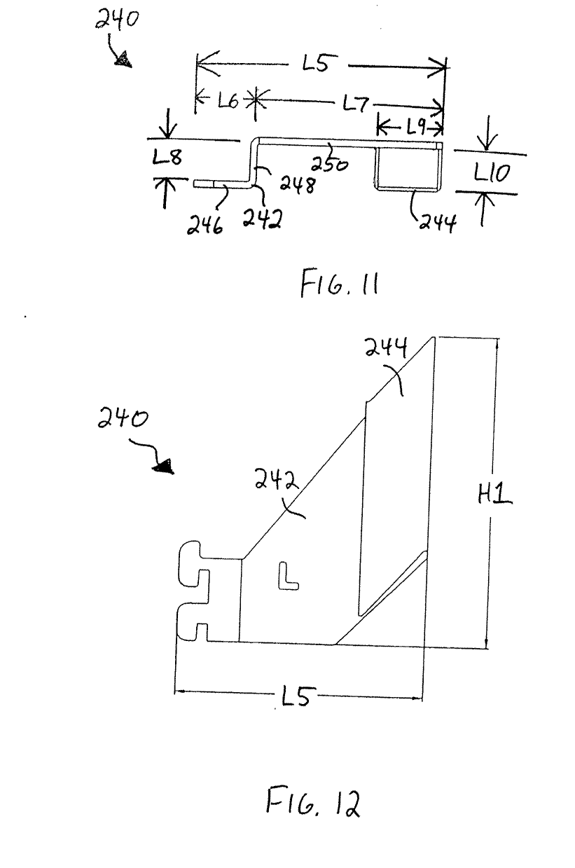

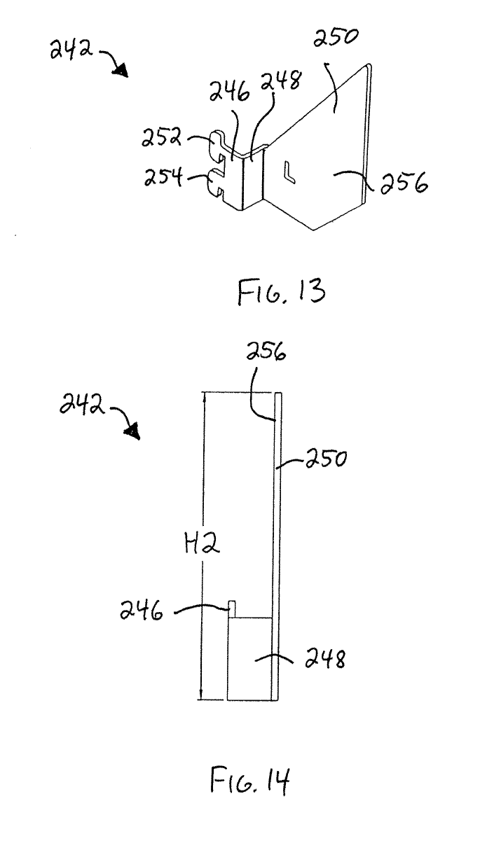

Alternate views of upright bracket 240 are shown in FIGS. 11 and 12, including a top view (FIG. 11) and a side view (FIG. 12). Dimensions will now be provided with reference to FIGS. 11 and 12 as one example of upright bracket 240. An overall length L5 of upright bracket 240 is typically in a range from about 3 inches to about 6 inches, and preferably from about 4 inches to about 5 inches.

Rear portion 242 includes first member 246, second member 248, and third member 250. First member 246 is parallel to third member 250 and spaced a length L8 that is typically in a range from about 0.5 inches to about 1.5 inches, and preferably from about 0.8 inches to about 1 inch. First member 246 has a length L6 that is typically in a range from about 0.5 inches to about 1.5 inches and preferably from about 1 inch to about 1.2 inches. Third member 250 has a length L7 that is typically in a range from about 2 inches to about 6 inches and preferably from about 3 inches to about 4 inches. Arm support member 244 has length L9 that is typically in a range from about 2 inch to about 1.4 inches, and preferably from about 1.2 to about 1.3 inches. Arm support member 244 has length L10 perpendicular to length L9 that is typically in a range from about 0.5 inches to about 1.5 inches, and preferably from about 0.7 inches to about 0.8 inches. Upright bracket 240 has an overall height Hi that is typically in a range from about 3 inches to about 10 inches, and preferably from about 5 inches to about 6 inches.

FIG. 13 is a perspective view of rear portion 242 of upright support 240 shown in FIG. 9. Rear portion 242 includes first member 246, second member 248, and third member 250. Rear portion 242 is formed, for example, from a sheet of material. The material is cut to the appropriate shape and then bent to form members 246, 248, and 250. First member 246 includes tabs 252 and 254, that are shaped to mate with slots 108 of product display system 100 (such as shown in FIG. 1). Tabs of any shape or size can be used to mate with any desired product display system. For example, tabs 252 and 254 are designed to mate with the slots of a Lozier display system.

At roughly a right angle to first member 246 is second member 248. Second member 248 extends between first member 246 and third member 250. Third member 250 is formed at roughly a right angle to second member 248, such that first member 246 and third member 250 are parallel to each other. Third member 250 includes an inner surface 256 to which arm support member 244 is fastened.

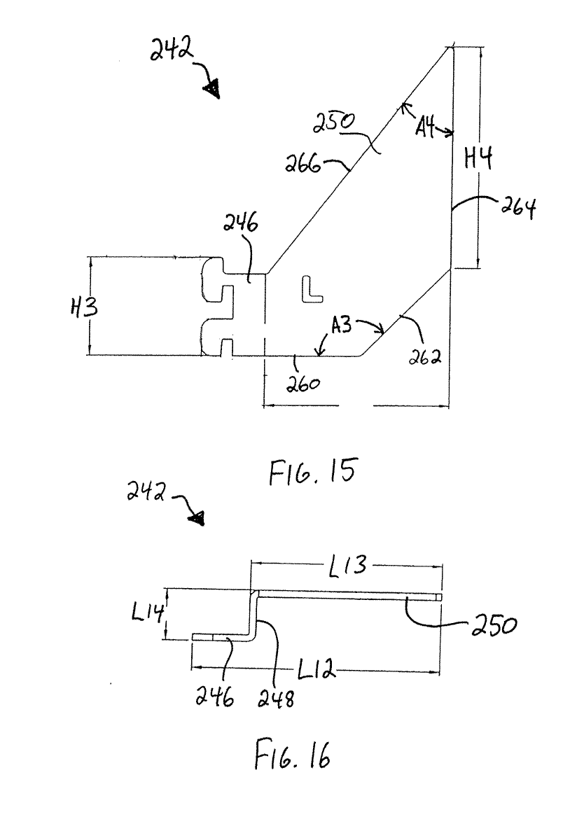

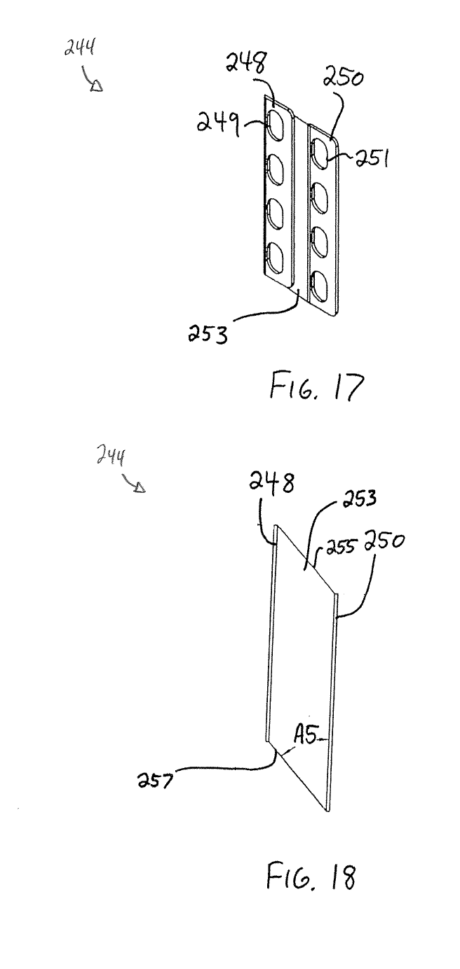

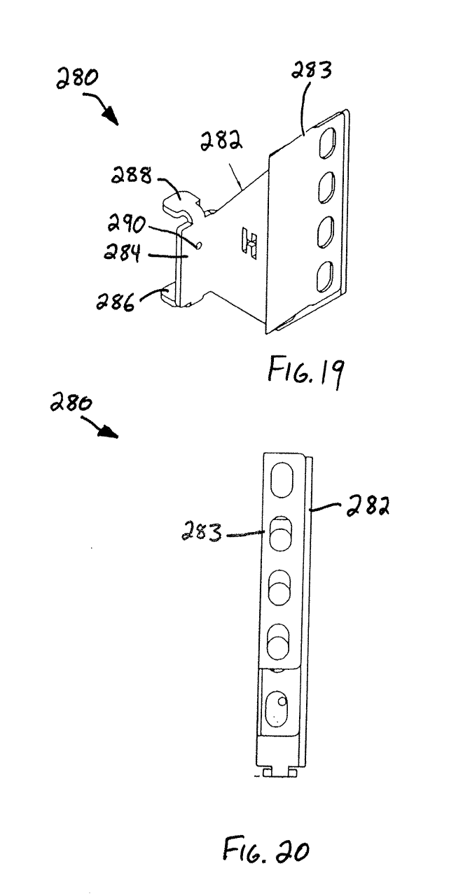

Alternate views of rear portion 240 are provided in FIGS. 14-16 including a front view (FIG. 14), side view (FIG. 15), and top view (FIG. 16). Rough dimensions will now be provided with reference to these alternate views to further explain one example of the invention.

Rear member 242 has an overall height H2 that is typically in a range from about 3 inches to about 9 inches, and preferably from about 5 inches to about 6 inches. First member 246 has height H3 that is typically in a range from about 1 inch to about 3 inches, and preferably from about 1.6 to about 2 inches.

Third member 250 includes first end 260, second end 262, third end 264, and fourth end 266. First end 260 is roughly perpendicular to third end 264. Second end 262 is opposite fourth end 266, but may or may not be parallel to fourth end 266. Third end 264, opposite first member 246, has height H4 that is typically in a range from about 2 to about 6 inches, and preferably from about 3 to about 4 inches. Third member 250 has an angle A3 between first side 260 and second side 262 that is typically in a range from about 105 degrees to about 165 degrees, and preferably from about 130 to about 140 degrees. Third member 250 also has angle A4 between third side 264 and fourth side 266 that is typically in a range from about 15 degrees to about 75 degrees, and preferably from about 35 degrees to about 40 degrees.

Rear portion 242 has an overall length L12 from about 2 inches to about 10 inches, and preferably from about 4 to about 5 inches. A length L13 of third member 250 is typically in a range from about 3 inches to about 6 inches, and preferably from about 3 inches to about 4 inches. Second member 248 has a length L14 from about 0.5 inches to about 1.5 inches, and preferably from about 0.8 inches to about 1.2 inches.

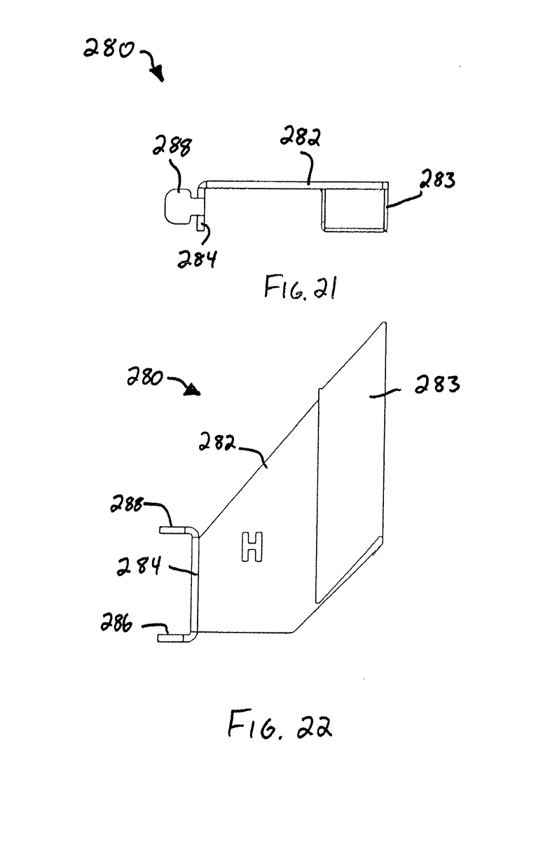

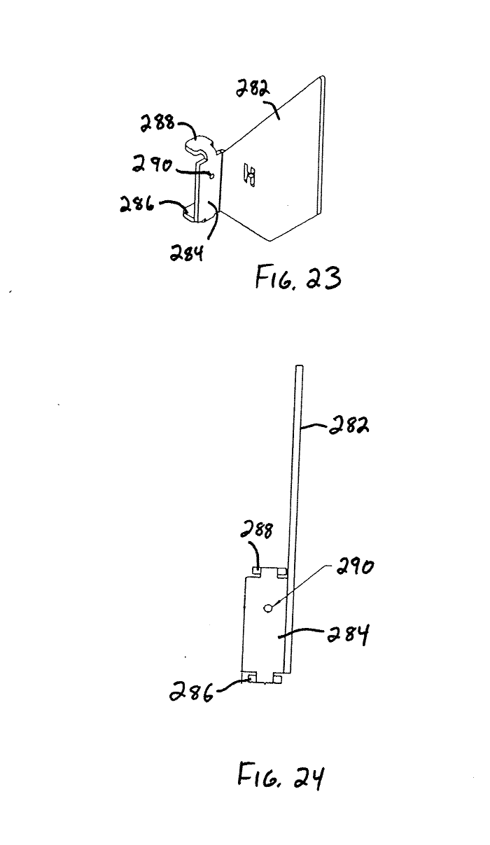

FIGS. 17-18 illustrate an example of arm support member 244. FIG. 17 is a perspective view of arm support member 244, and FIG. 18 is a side view of arm support member 244. Arm support member 244 includes face plate 248 having hole 249, rear plate 250 having hole 251, and side plate 253. Holes 249 are drilled within face plate 248 with roughly uniform spacing between each hole. Similarly, holes 251 are drilled within rear plate 250 with roughly uniform spacing between each hole. Except for the location, face plate 248 and rear plate 250 approximately the same. Face plate 248 and rear plate 250 are roughly parallel to each other, and side plate 253 is roughly perpendicular to face place 248 and rear plate 250.

Arm support member 244 includes top 225 and bottom 257 of side plate 253. Angle A5 is formed between bottom 257 and rear plate 250 and having an angle that is typically in a range from about 15 degrees to about 75 degrees, and preferably from about 35 degrees to about 45 degrees.

FIGS. 19-28 illustrate various views of upright bracket 280, which is another example of an upright bracket that can be used to connect sign display system 200 to product display system 200. For example, upright bracket 280 is designed to connect with a Hussmann display system.

Upright bracket 280 is the same as upright bracket 240 (FIGS. 9-18), except for the design of rear portion 282. Instead of having vertically oriented tabs, upright bracket 280 has two horizontally oriented tabs 286 and 288, one extending from a top of member 284 (tab 288) and one from a bottom of member 284 (tab 286). The tabs extend rearward from rear portion 282, and are generally parallel to each other. In addition, upright bracket 280 includes hole 290 for the insertion of a fastener such as a screw, pin, or any other desired fastener.

FIGS. 29-31 illustrate various views of upright bracket 300, which is another example of an upright bracket that can be used to connect sign display system 200 to product display system 200.

FIG. 29 is a side view of upright bracket 300, including body 302 and tabs 304 and 306. Body 302 includes one or more holes 308, first side 310, second side 312, third side 314, fourth side 316, fifth side 318, and sixth side 320. First side 310 extends between tab 304 and second side 312 and is generally parallel with fourth side 316. Third side 314 extends between second side 312 and fourth side 316 and is generally perpendicular to fifth side 318 and parallel to sixth side 320. Fifth side 318 extends between fourth side 316 and sixth side 320. Tabs 304 and 306 extend out from sixth side 320 of body 302 and are shaped to engage slots in upright supports (e.g. 108 shown in FIG. 1).

FIG. 30 is an alternate side view of upright bracket 300 including body 302, tabs 304 and 306, first through sixth sides 310, 312, 314, 316, 318, and 320, and support tubes 322. Support tubes 322 are hollow cylindrical tubes that extend generally parallel with first side 310 and fourth side 316. One or more support tubes 322 are sized to receive extension arms (e.g. 206 and 208 shown in FIG. 1), and include one or more holes 330 that match up with holes 308 in body 302. A fastener such as a screw or a pin can be inserted through holes 308 and 330 and into a hole in the extension arm to fasten the extension arm to upright bracket 300. Support tubes 322 are fastened to body 302 by any desired fastening means, including by welding, gluing, screwing, or any other desired method.

Rough dimensions will now be provided to explain one example of upright bracket 300. First side 310 has length L20 that is typically in a range from about 3 inches to about 9 inches, and preferably from about 5 inches to about 6 inches. Second side 312 has length L21 that is typically in a range from about 0.3 inches to about 1.5 inches, and preferably from about 0.6 inches to about 0.8 inches. Third side 314 has length L22 that is typically in a range from about 1 inch to about 5 inches, and preferably from about 2.5 inches to about 3.5 inches. Fourth side 316 has length L23 that is typically in a range from about 1 inch to about 5 inches, and preferably from about 2 inches to about 3 inches. Fifth side 318 has length L24 that is typically in a range from about 1 inch to about 5 inches, and preferably from about 2 to about 3 inches. Support tubes 322 have length L24 that is typically in a range from about 1 inch to about 5 inches, and preferably from about 2 inches to about 3 inches. Angle A6 is formed between fourth side 316 and fifth side 318 that is typically in a range from about 195 degrees to about 255 degrees, and preferably from about 220 degrees to about 230 degrees.

FIG. 31 is a front view of upright support 300 including body 302 and support tubes 322. Support tubes 322 can be made of hollow tubing having an inner diameter sized to receive the extension arms (e.g., extension arms 206 or 208 shown in FIG. 1). In one example, the diameter is typically in a range from 0.125 inches to 1 inch, and preferably from 0.25 inches to 0.5 inches. Support tubes 322 are generally parallel and uniformly spaced from each other. In the illustrated example, four support tubes 322 are shown, but it is recognized that any number of support tubes could be used.

One of the benefits of sign display system 200 is that it is highly customizable. In some situations it is desirable to display signs in other manners, other than by extending it from upright supports (e.g., supports 108 shown in FIG. 1).

FIG. 32 is a perspective view of stand-alone sign display 400. Display 400 includes stand-up brackets 402, horizontal support bar 404, side retaining members 406, and sign 408. Stand-up brackets 402 connect to horizontal support bar 404 and provide stability to sign display 400, enabling it to stand on its own, such is if placed on the floor or on a shelf. Side retaining members 404 attach to the sides of horizontal support bar 404, and include channels for holding sign 408. Sign 408 may contain any information or designs that are to be displayed to the customer. Sign 408 can be slid into side retaining members 406, which holds sign 408 in place.

FIG. 33 is a perspective view of stand-up brackets 402 including leg 410 and foot 412. Leg 410 extends vertically and is connected to a mid-section of horizontally extending foot 412. Holes 414 are provided in leg 410 for connecting leg 410 with horizontal support beam 404 by a fastener, such as a screw, pin, or any other type of fastener. Similarly, foot 412 includes holes 416 that are provided for connecting foot 412 with a floor, shelf, or any other horizontal surface with a fastener.

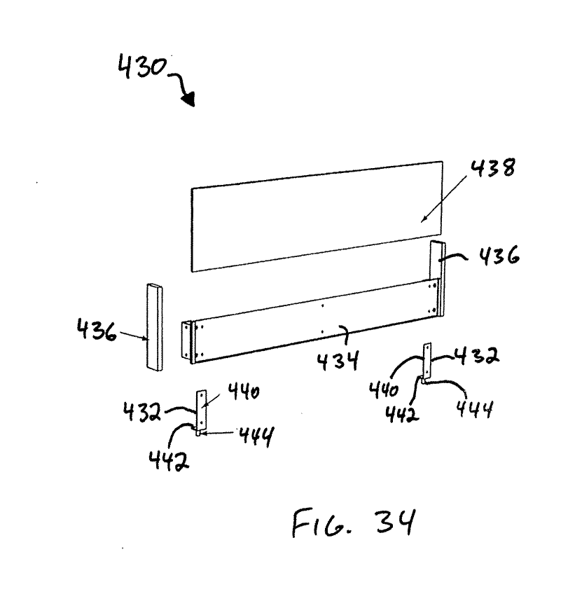

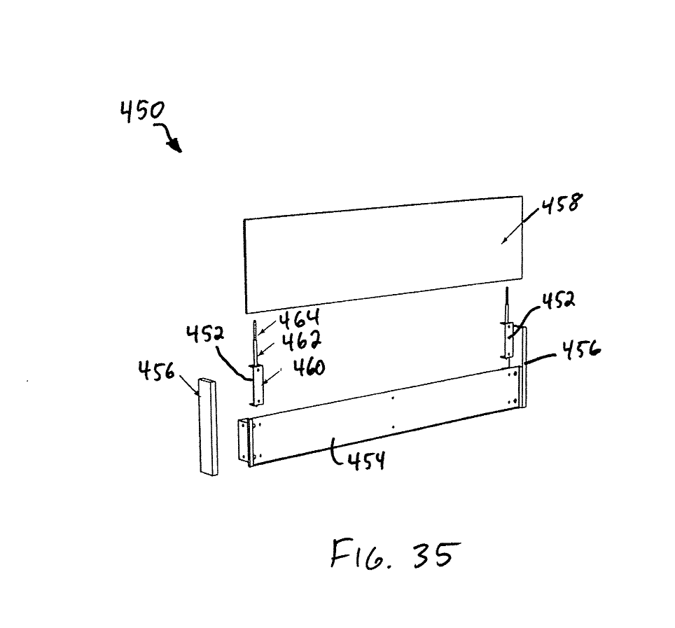

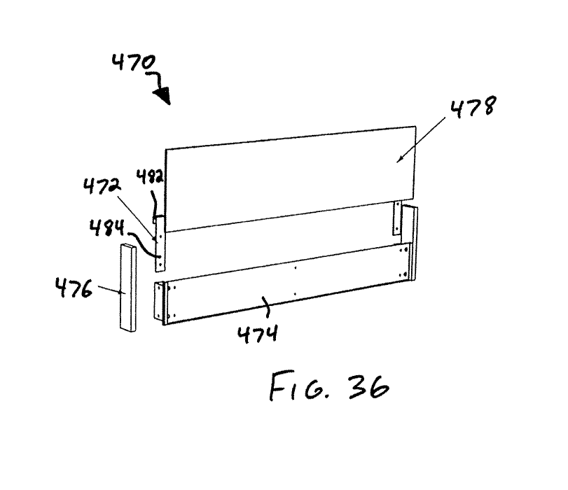

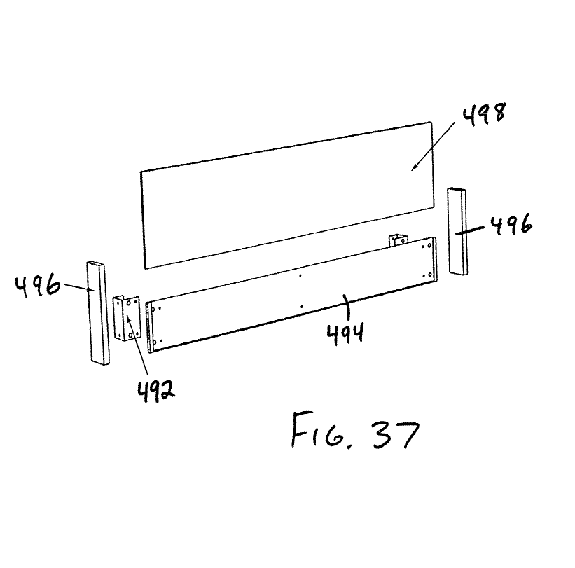

FIG. 34 is a perspective view of peg-hole sign display 430 including peg stands 432, horizontal support beam 434, side retaining members 436, and sign 438. Peg-hole sign display 430 is designed to be inserted into holes in a shelf or other horizontal surface to display sign 438 to a customer. Peg stands 432 include leg 440, foot 442, and peg 444. Leg 440 extends vertically and connects with one side of horizontal foot 442. Leg can be fastened to horizontal support beam 434 by any desired fastening method. Peg 444 extends vertically from a bottom surface of foot 442, and is shaped to fit into a hole in a shelf or other horizontal surface. Peg 444 can be connected to foot 442 such as by welding, gluing, or any other desired method.

FIG. 35 is a perspective view of hanging sign display 450 including hanging supports 452, horizontal support beam 454, side retaining members 456, and sign 458. Hanging sign display 450 is designed to hang from the bottom of a ceiling, shelf, or any other horizontal surface to display sign 458 to customers. Hanging supports 452 include first member 460, second member 462, and third member 464. Second member is connected between first member 460 and third member 464. First member 460 can be fastened to horizontal support beam 454 by screws or any other fastener. Second member 462 is an extension beam enabling sign display 450 to hang an appropriate distance below the horizontal surface. Second member 462 can have any desired length. Third member 464 is a fastener for connecting sign display 450 to a horizontal surface. For example, third member 464 can include screw threads.

FIG. 36 is a perspective view of side hanging sign display 470 including hooks 472, horizontal support beam 474, side retaining members 476, and sign 478. Side hanging sign display 470 is designed to be hooked over the side of a shelf or other surface having a lip over which hooks 472 can be engaged to display sign 478 to customers. Hooks 472 includes first member 482 and second member 484. Second member 484 can be fastened to horizontal support beam 474 by screws or any other fastener. First member 482 is connected to one end of second member 484 and includes a hook-shape for engagement with a lip on a shelf or other surface.

FIG. 37 is a perspective view of edge connecting sign display 490 including edge brackets 492, horizontal support beam 494, side retaining members 496, and sign 498. Edge connecting sign display 490 is designed for connection with the outer edges of upright supports (e.g. 104 and 106 shown in FIG. 1). They can be slid down from the top of upright supports and fastened to the appropriate location by screws, pins, or any other desirable fastener. Edge brackets 492 can also be connected to horizontal support beam 494. Side retaining members 496 are connected to the sides of horizontal support member 494. Sign 498 is inserted into channels in side retaining member 496 to provide the necessary support for displaying sign 498.

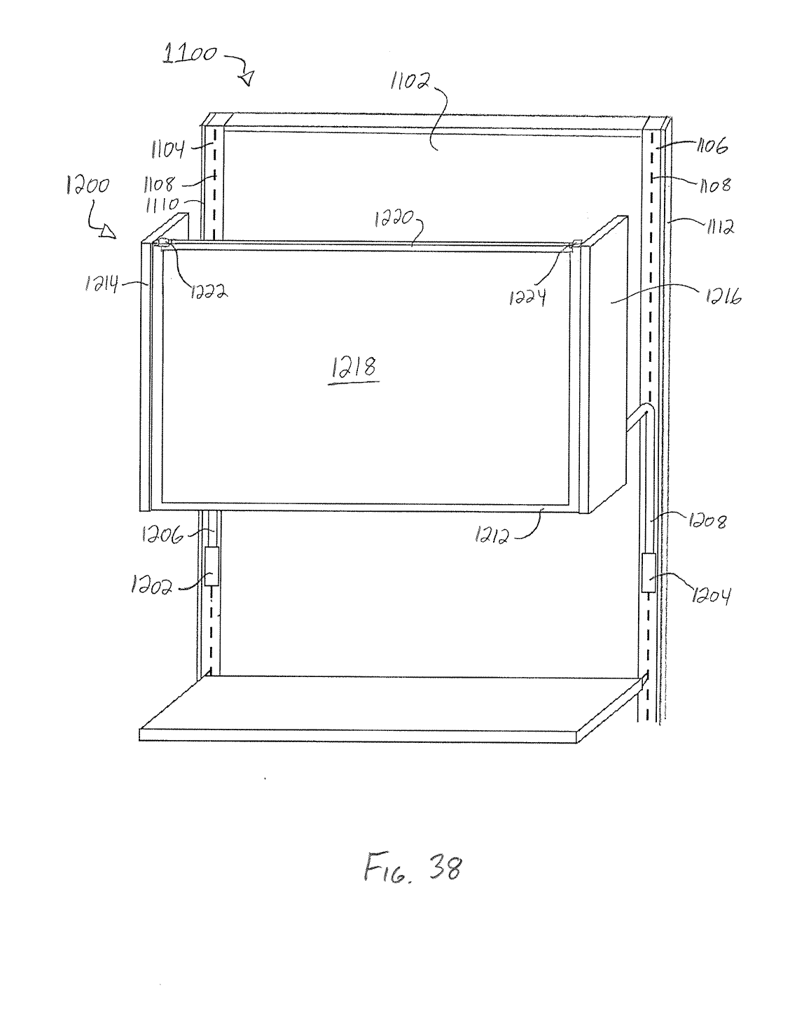

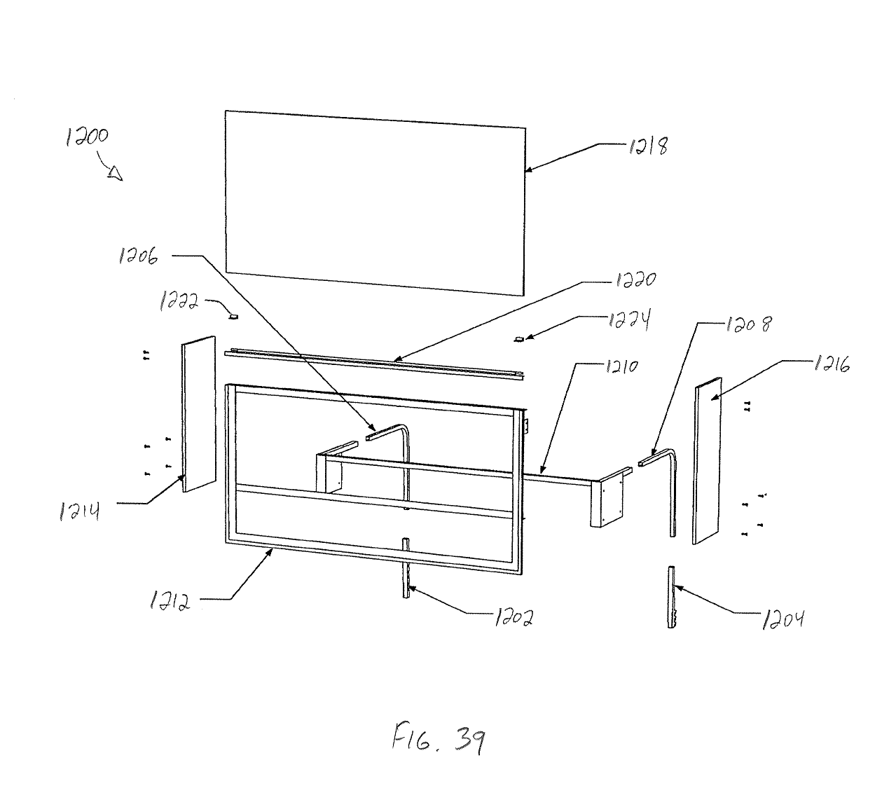

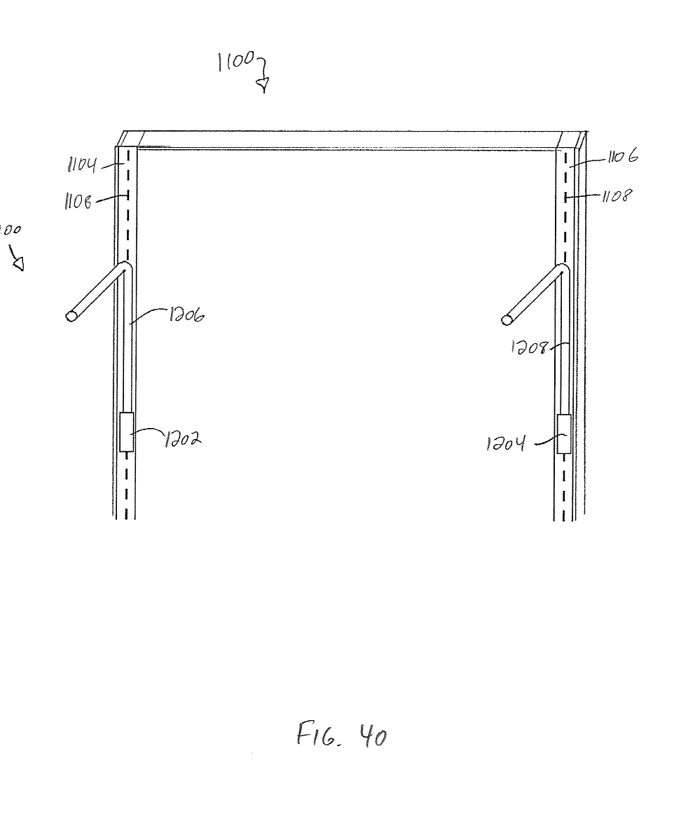

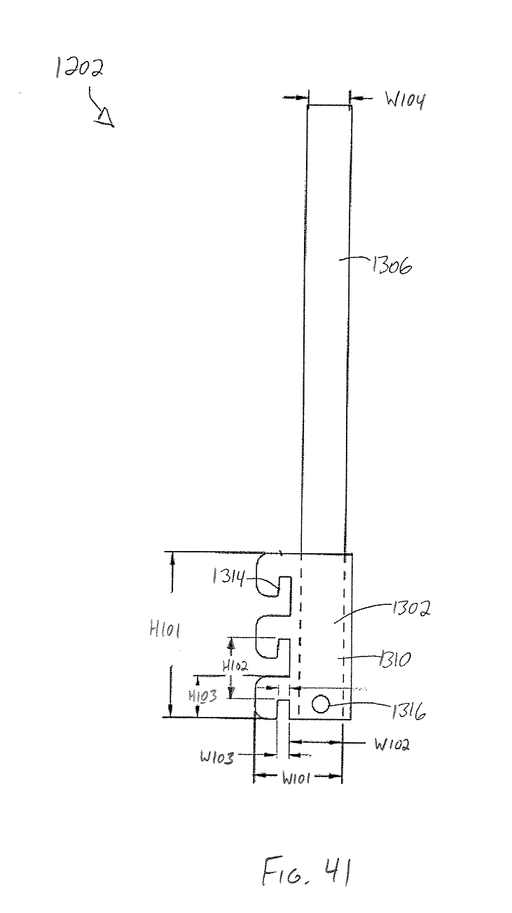

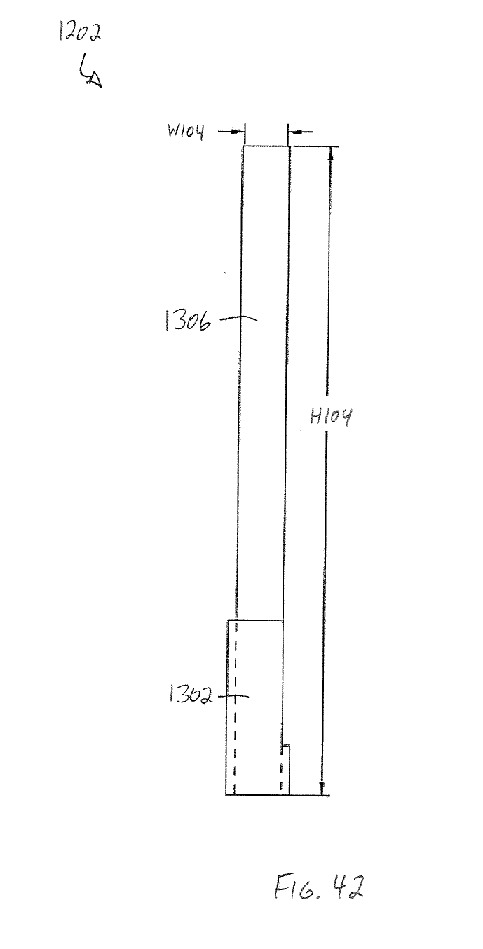

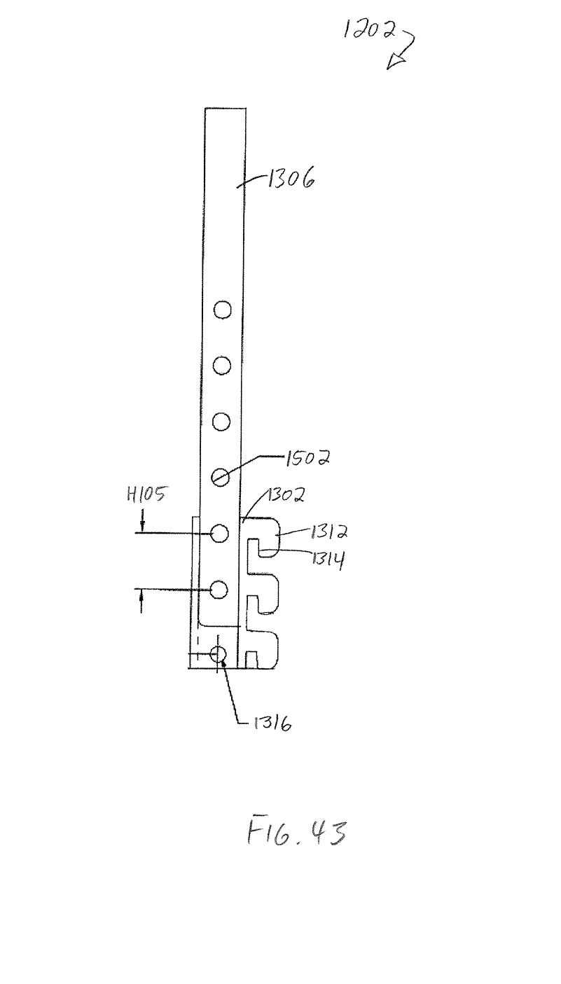

FIGS. 38 and 39 provide a general overview of elevated sign display 1200. FIG. 38 is a perspective view of product display system 1100 and attached elevated sign display 1200. FIG. 39 is an exploded view of elevated sign display 1200. Product display system 1100 is an example of a typical existing system used for the display of products, such as in a retail store. Product display system 1100 includes a vertical back panel 1102 disposed between two vertically extending upright supports 1104 and 1106. A face of each of the upright supports 1104 and 1106 includes a plurality of uniformly spaced slots 1108. A side of each of the upright supports 1104 and 1106 opposite back panel 1102 may be covered with upright end trim 1110 and 1112 to provide a finished look to the outer sides of product display system 1100. In addition, a top rail 1114 is disposed above back panel 1102 and between upright supports 1104 and 1106. Shelves such as shelf 1116 are attached to product display system 1100 by inserting tabs 1118 located on the rear of each side of shelf 1116 into slots 1108 of upright support 1104 and 1106. Shelves 1116 include a horizontal surface for the placement of products or anything else that is to be displayed.

Elevated sign display 11200 can be connected to product display system 1100 for the display of information pertaining to a product or the display of a decorative sign to improve the appearance of product display system 1100. The sign may be intended to display relevant information pertaining to the product, such as the name of the product, the name of the manufacturer, a special price of the product, or information explaining why the customer may desire to purchase the product. In addition, the sign may include pictures or designs intended to draw the customer's attention to the product or to improve the aesthetic appearance of the display.

Sign display system 1200 includes adjustable upright brackets 1202 and 1204, extension arms 1206 and 1208, adjustable frame 1210 (not shown in FIG. 38), frame assembly 1212, side panels 1214 and 1216, sign 1218, door 1220, and hinges 1222 and 1224. Adjustable upright brackets 1202 and 1204 connect to and support extension arms 1206 and 1208. Adjustable upright brackets 1202 and 1204 are designed to connect with upright supports 1104 and 1106 of product display system 1100. Upright brackets 1202 and 1204 are described in more detail herein. Extension arms 1206 and 1208 include portions that extend in a generally vertical direction from upright brackets 1202 and 1204, and other portions that extend in a generally horizontal direction that is generally perpendicular to the front surface of vertical back panel 1102.

An adjustable frame 1210 (not shown in FIG. 38, but located behind sign 1218 and side panels 1214 and 1216) extends between and connects to the ends of extension arms 1206 and 1208 opposite adjustable upright brackets 1202 and 1204. Frame assembly 1212 is connected to adjustable frame 1210. Frame assembly 1212 is oriented generally vertically, such that it supports and displays sign 1218 to customers walking by or viewing products on shelf 1116. Frame assembly 1212 is another example of a sign support assembly. Side panels 1214 and 1216 are connected to the sides of frame assembly 1212. Side panels 1214 provide a finished appearance to elevated sign display 1200, such as by concealing some of adjustable frame 1210 from view. Door 1220 is pivotally connected to a top side of frame assembly 1212 by hinges 1224. Door 1220 encloses a top side of sign 1218, but can be pivoted from a closed position to an open position to allow sign 1218 to be slidably inserted or removed from frame assembly 1212.

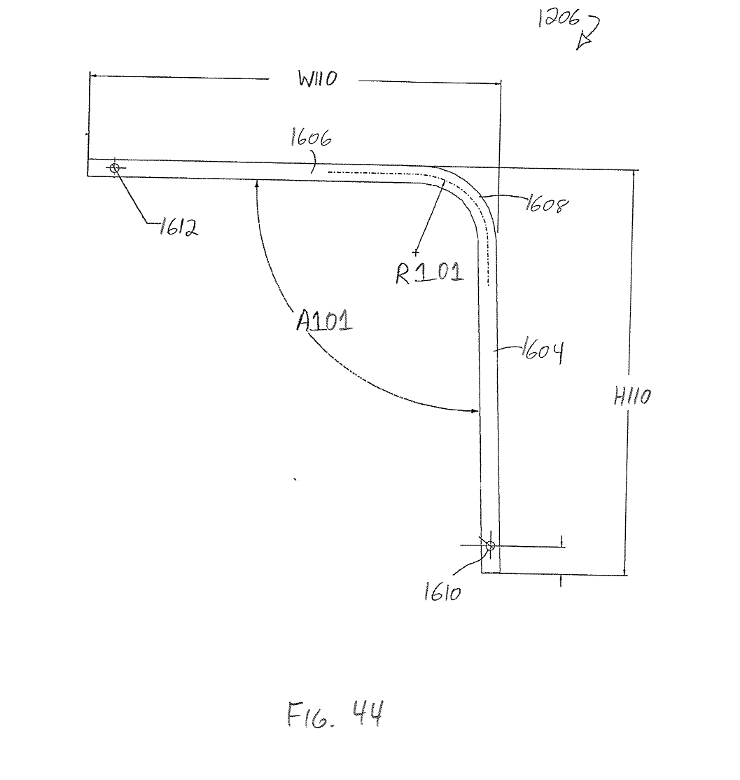

FIG. 40 is a perspective view illustrating portions of sign display system 1200 being installed to product display system 1100. More specifically, FIG. 40 illustrates adjustable upright brackets 1202 and 1204 and extension arms 1206 and 1208. Upright brackets 1202 and 1204 include mounting brackets 1302 and 1304 and support tubes 1306 and 1308, respectively, that are fastened together by, for example, welding, an adhesive, or fasteners such as screws, nails, or bolts. Alternatively, upright brackets 1202 and 1204 are each molded as a single piece. Mounting brackets 1302 and 1304 are designed to connect with slots 1108 of product display system 1100. Support tubes 1306, 1308 extend in a generally vertically upward direction from mounting brackets 1302 and 1304. Support tubes 1306, 1308 adjustably support extension arms 1206 and 1208, respectively.

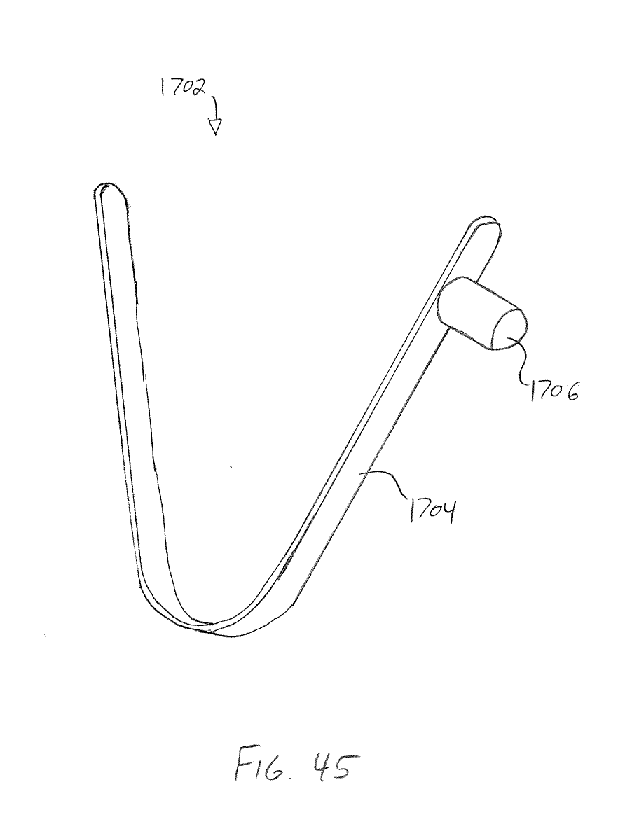

To begin installation of sign display system 1200, upright brackets 1202 and 1204 are first installed into slots 1108 of product display system 1100. First, the teeth (shown in FIG. 41) of one of the adjustable upright brackets 1202, 1204 are inserted into slots 1108. The adjustable upright brackets 1202, 1204 are then moved in a vertically downward direction relative to product display system 1100 to lock the upright bracket into place. One end of extension arms 1206 and 1208 is then inserted into the respective upright bracket, and adjusted to the desired height.

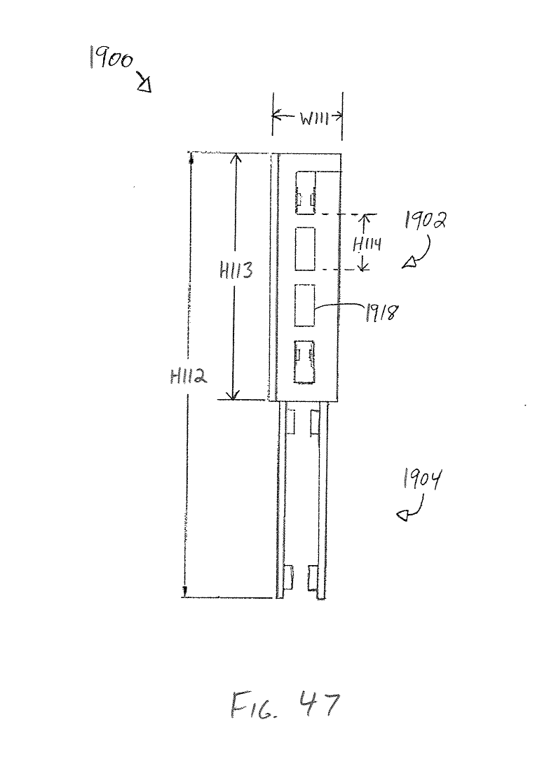

To allow for easy adjustment of the vertical height of extension arms 1206 and 1208, support tubes 1306 and 1308 include a plurality of position holes (e.g., 1502, shown in FIG. 43) formed in a side portion of each of support tubes 1306 and 1308. A spring button (e.g., 1604, shown in FIG. 44) is positioned at a lower end of extension arms 1206 and 1208. The spring button is sized to fit within position holes (e.g., 1502, shown in FIG. 43) of support tubes 1306 and 1308.

Extension arms 1206 and 1208 are installed into adjustable upright brackets 1202 and 1204, respectively, by compressing the spring button while inserting one end of the extension arm into the adjustable upright bracket. The extension arm 1206 or 1208 is then adjusted to the desired position, such that spring button (e.g., 1604, shown in FIG. 44) extends through and is supported by one of the position holes (e.g., 1502, shown in FIG. 43). The same procedure is followed to install the other extension arm 1208 or 1206. Alternative embodiments include a pin or other fastener to connect extension arms 1206 and 1208 with adjustable upright brackets 1202 and 1204.

Adjustable upright brackets 1202 and 1204 include multiple position holes (e.g., 1502, shown in FIG. 43) that allow extension arms 1206 and 1208 to be arranged in various positions relative to the respective adjustable upright bracket 1202 and 1204. Furthermore, the spring button (e.g., 1502 of extension arms 1206 and 1208) makes it easy to adjust the position of extension arms 1206 and 1208 relative to adjustable upright bracket 1202 and 1204. To do so, the spring button is compressed, and the extension arm is adjusted as desired.

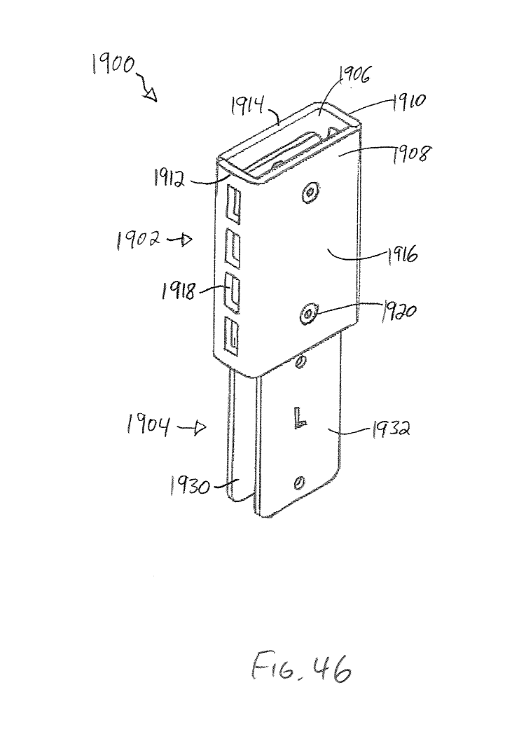

FIGS. 41-43 illustrate various views of example adjustable upright bracket 1202. Adjustable upright bracket 1202 is a mirror image of adjustable upright bracket 1204, and therefore will not be separately detailed herein. FIG. 41 is a left side view of adjustable upright bracket 1202. FIG. 42 is a front view of adjustable upright bracket 1202. FIG. 43 is a right side view of adjustable upright bracket 1202.

In the illustrated embodiment, adjustable upright bracket 1202 includes mounting bracket 1302 and support tube 1306. Mounting bracket 1302 can be fastened to support tube 1306 by welding. Alternatively, any other suitable fastener or connecting structure is used. Mounting bracket 1302 includes angled bracket 1310, teeth 1312, notches 1314, and stop hole 1316. One or more teeth 1312 extend from one side of angled bracket 1310, and include notches 1314. Teeth 1312 and notches 1314 are sized and shaped to engage with slots 1108 of product display system 1100, such as shown in FIG. 41. Various teeth and notch designs can be used, depending on the type of product display system 1100 that is being used. In this example, teeth 1312 and notches 1314 are configured to install into a Lozier style product display system. Mounting bracket 1302 includes any number of teeth, and preferably two or more for added stability. Three teeth are shown in the illustrated example. Edges of teeth 1312 are rounded to aid in inserting and removing teeth 1312 relative to slots 1108 of product display system 1100 (shown in FIG. 41). Adjustable upright bracket 1202 also includes stop hole 1316 through which a bolt or pin is inserted to prevent extension arm 1206 from extending too far through adjustable upright bracket 1202. Stop hole 1316 can also extend through a portion of support tube 1306.

Some example embodiments include mounting bracket 1302 having the following dimensions. H101 is the overall height of mounting bracket 1302. H101 is typically in a range from about 1 inch to about 6 inches, and preferably from about 2 inches to about 4 inches. H102 is the distance between a top side of one notch to the top side of an adjacent notch. H102 is designed to correspond with the distance between a top of a slot 1108 of product display system 1100 and the top of an adjacent slot 1108. H102 is typically in a range from about 0.2 inches to about 4 inches, and preferably from about 0.5 inches to about 1.5 inches. H103 is the height of tooth 1312, which is sized to fit within slot 1108 of product display system 1100. H103 is typically in a range from about 0.1 inches to about 3 inches, and preferably from about 0.4 inches to about 0.8 inches.

W101 is the overall width of mounting bracket 1302. W101 is typically in a range from about 0.5 inches to about 4 inches, and preferably from about 1 inch to about 3 inches. W2 is the width of angled bracket 1310 from notch 1314 to the opposite side of angled bracket 1310. W2 is typically in a range from about 0.2 inches to about 4 inches, and preferably from about 0.5 inches to about 1 inch. W3 is the width of notch 1314. W3 is typically in a range from about 0.01 inches to about 1 inch, and preferably from about 0.1 inches to about 0.3 inches.

Adjustable upright bracket 1202 also includes support tube 1306. In one embodiment, support tube 1306 is a hollow tube including a plurality of position holes 1502. Support tube 1306 has a generally square cross-sectional shape. Alternatively, other cross sectional shapes can be used. One benefit of square or rectangular cross-sectional shapes is that it provides additional resistance to rotational forces, as opposed to a circular or elliptical cross-sectional shape.

Some example embodiments include the following dimensions. W4 is the outer width of support tube 1306. W4 is typically in a range from about 0.2 inches to about 2 inches, and preferably from about 0.4 inches to about 0.8 inches. H104 is the overall height of adjustable upright bracket 1202 and also the height of support tube 1306. H104 is typically in a range from about 4 inches to about 24 inches, and preferably from about 8 inches to about 12 inches. H105 is the distance between the centers of position holes 1502. H105 is typically in a range from about 0.1 inches to about 3 inches, and preferably from about 0.5 inches to about 1.5 inches. W5 is the thickness of angled bracket 1310. W5 is typically in a range from about 0.01 inches to about 0.3 inches, and preferably from about 0.1 inches to about 0.2 inches. D1 is the diameter of stop hole 1316. D1 is typically in a range from about 0.1 inches to about 0.5 inches, and preferably from about 0.2 inches to about 0.4 inches.

FIG. 44 is a side view of an example left extension arm 1206. Extension arm 1206 includes vertical member 1604, horizontal member 1606, and corner member 1608. Corner member 1608 connects vertical member 1604 and horizontal member 1606. At each end of extension arm 1206 is a button hole, including button hole 1610 in vertical member 1604 and button hole 1612 in horizontal member 1612. Spring buttons (e.g., 1702 shown in FIG. 45) are inserted within hollow extension arm 1206, such that button (e.g., 1706 shown in FIG. 45) extends through the respective button hole.

Some example embodiments include extension arm 1206 having the following dimensions. H110 is the overall height of extension arm 1206. H110 is typically in a range from about 6 inches to about 24 inches, and preferably from about 12 inches to about 16 inches. W110 is the overall depth of extension arm 1206. W110 is typically in a range from about 6 inches to about 24 inches, and preferably from about 12 inches to about 16 inches. A101 is the angle between vertical member 1604 and horizontal member 1606. A101 is typically in a range from about 60 degrees to about 130 degrees, and preferably from about 85 degrees to about 95 degrees. R101 is the radius of curvature of corner 1608. R101 is typically in a range from about 1 inch to about 6 inches, and preferably from about 2 inches to about 3 inches.

FIG. 45 is a perspective view of an example spring button 1702. Spring button 1702 includes spring 1704 and button 1706. Spring buttons 1702 are inserted within vertical member 1604 of extension arm 1206 and horizontal member 1606 of extension arm 1206, such that button 1706 extends at least partially through spring button holes 1610 and 1612. Spring button 1702 enables easy adjustment of extension arm 1206 relative to adjustable upright bracket 1202 and adjustable frame 1210. Various other known styles of spring buttons can also be used.

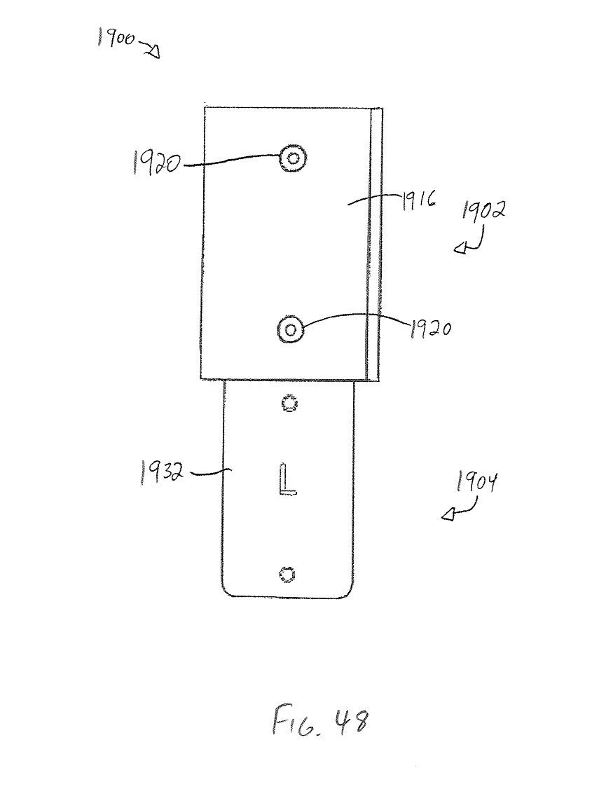

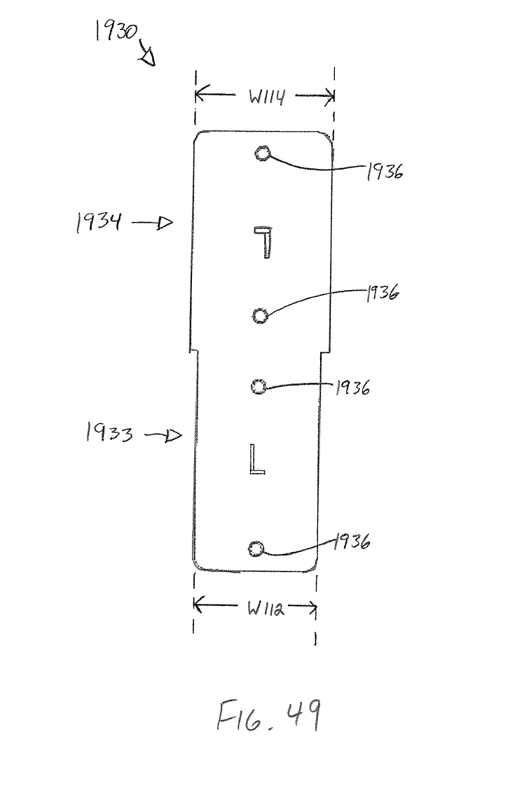

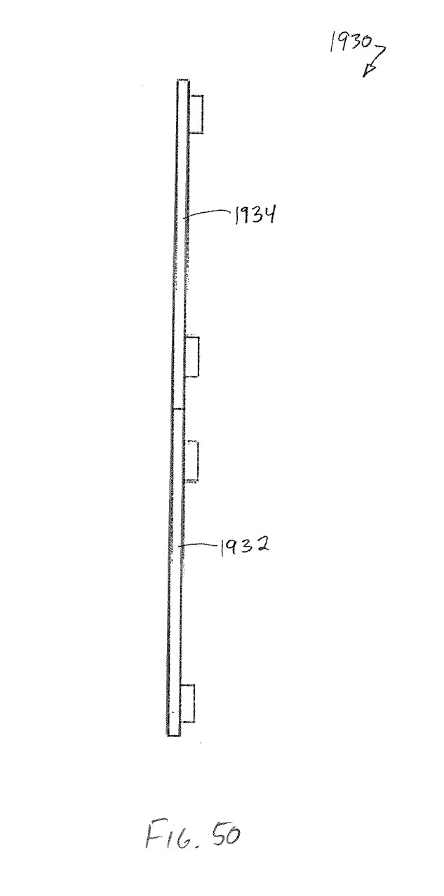

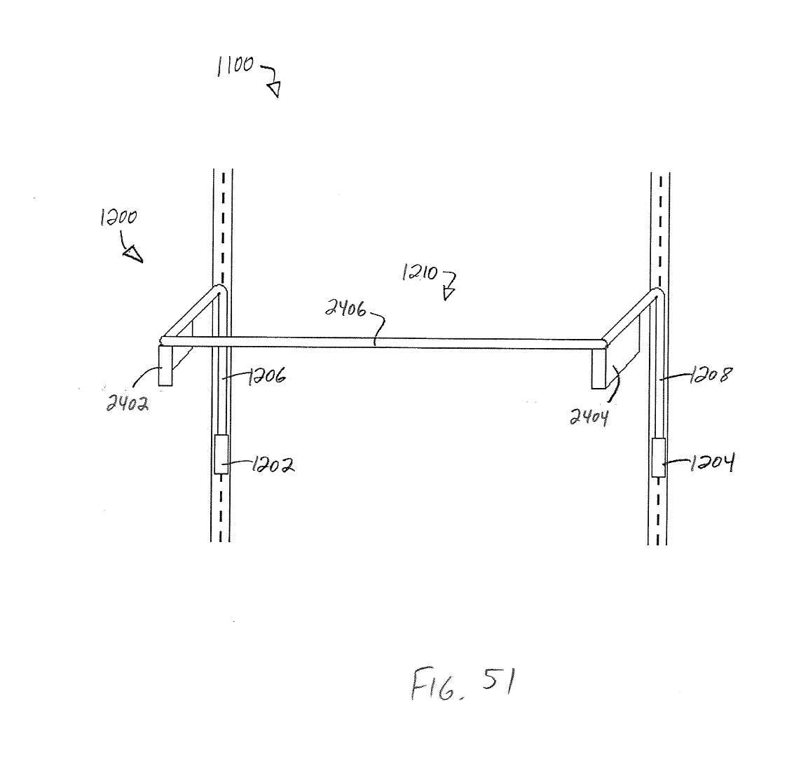

FIGS. 46-48 illustrate an example upright support extension 1900. FIG. 46 is a perspective view of the example upright support extension 1900. FIG. 47 is a front view of the example upright support extension 1900. FIG. 48 is a side view of the example upright support extension 1900.

In some embodiments it is undesirable to connect elevated sign display 1200 directly to upright supports 1104 and 1106. For example, the product display system 1100 can be assembled such that shelf 1116 is connected to the uppermost slots 1108 of product display system 1110, making them unavailable for connection with elevated sign display 1200. In these and other situations, upright support extension 1900 can be used to connect elevated sign display 1200 to product display system 1100.

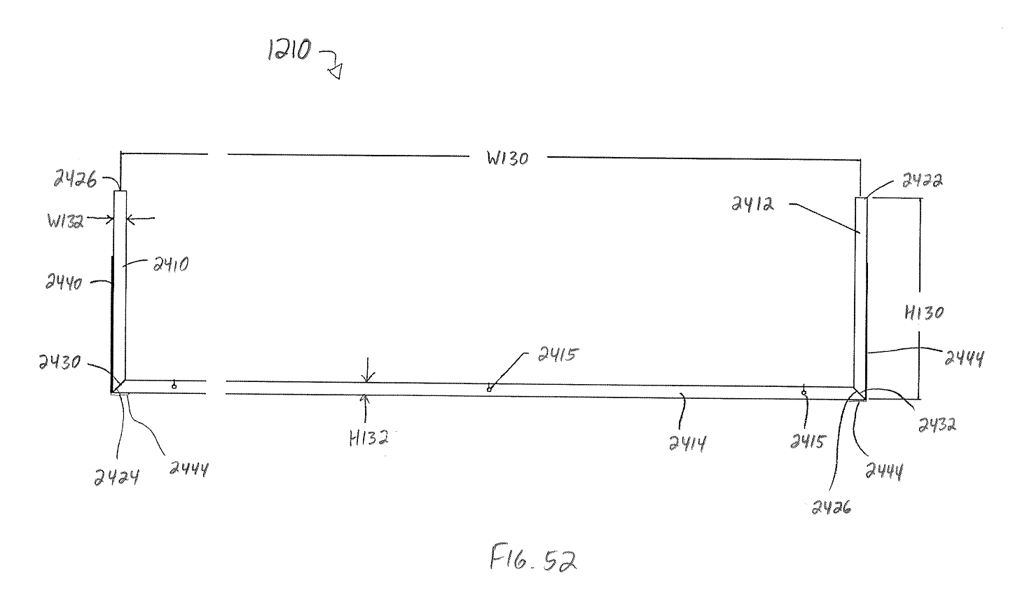

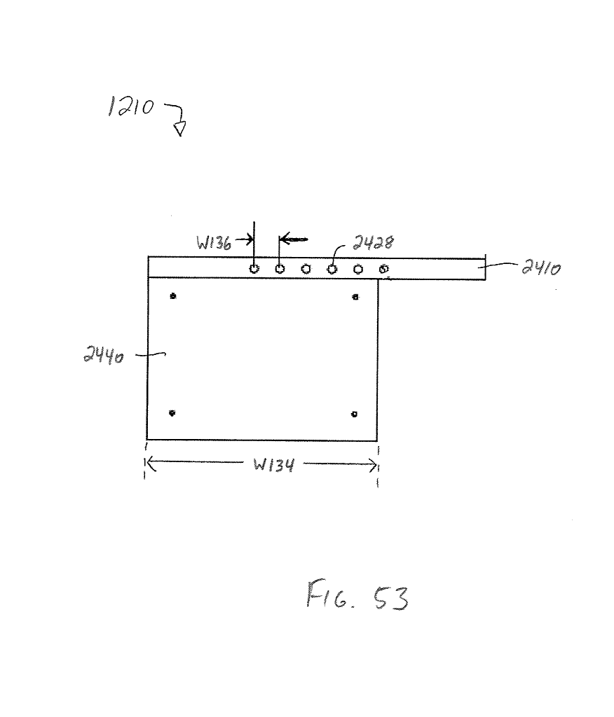

Upright support extension 1900 includes upright support member 1902 and upright adapter 1904. Upright support member 1902 includes a body, which in the example embodiment is formed of two angled brackets 1906 and 1908. Each angled bracket 1906 and 1908 includes a face 1910 and 1912 and a side 1914 and 1916. A plurality of uniformly spaced slots 1918 are disposed within faces 1910 and 1912 of upright support member 1902. Slots 1918 are sized and configured to engage with and support teeth 1312 of adjustable upright bracket 1202, such as shown in FIG. 41. In one embodiment, angled brackets 1906 and 1908 are connected by welding angled brackets 1906 and 1908 together at each end. Alternatively, fasteners are used. In addition, fasteners 1920 are inserted through sides 1914 and 1916 to connect upright support member 1902 with upright adapter 1904. Upright support member 1902 also includes upright adapter 1904 having plates 1930 and 1932, described in more detail with reference to FIGS. 49-50.

Some example embodiments of upright support extension 1900 include the following dimensions. H112 is the overall height of upright support extension 1900. H112 is typically in a range from about 4 inches to about 16 inches, and preferably from about 7 inches to about 9 inches. H113 is the height of upright support member 1902. H113 is typically in a range from about 2 inches to about 8 inches, and preferably from about 3 inches to about 5 inches. H114 is the distance between bottom edges of slots 1918. H114 is typically in a range from about 0.5 inches to about 3 inches, and preferably from about 0.7 inches to about 1.3 inches. W111 is the overall width of upright support extension 1900. W111 is typically in a range from about 0.3 inches to about 3 inches, and preferably from about 0.5 inches to about 1.5 inches.

FIGS. 49 and 50 illustrate an example of plate 1930. Plate 1932 is the same as plate 1930 in this embodiment. FIG. 47 is a side view of plate 1930. FIG. 48 is a front view of plate 1930. One of the benefits of plate 1930 is that it includes variable size settings that allow upright support extension 1900 to connect with various sized upright supports 1104 and 1106, shown in FIG. 40. Some upright supports 1104 and 1106 are manufactured in two or more sizes, such as a regular size and a heavy duty size. Therefore, upright support extension 1900 includes at least two size settings that enable upright support extension 1900 to connect with at least two different sized upright supports.

Plate 1930 includes first region 1933 and second region 1934. Regions 1933 and 1934 are generally rectangular regions, although various other shapes are possible in other embodiments. Some corners of regions 1933 and 1934 are rounded in some embodiments to ease insertion of plate 1930 into a top orifice of upright supports 1104 or 1106. First regions 1933 and 1934 include fastener holes 1936, through which fasteners 1920 are used to connect one of the regions with upright support member 1902. After fastening, the opposite region extends from upright support member 1902, for insertion into the top of the upright support (e.g., 1104 or 1106, shown in FIG. 38). To adjust between size settings, fasteners 1920 are unfastened to disconnect plates 1930 and 1932 from upright support member 1902. Plates 1930 and 1932 are removed from upright support member 1902, rotated relative to upright support member 1902, and inserted into back into upright support member 1902. Fasteners 1920 are then used to reconnect plates 1930 and 1932 to upright support member 1902.

Some example embodiments of plate 1930 include the following dimensions. H116 is the overall height of plate 1930. H116 is typically in a range from about 4 inches to about 16 inches, and preferably from about 7 inches to about 9 inches. H118 is the height of first region 1933. H120 is the height of second region 1934. In one embodiment, H118 and H120 are the same. Alternatively, H118 and H120 have different heights. H118 and H120 are typically in a range from about 1 inch to about 12 inches, and preferably from about 3 inches to about 4 inches. W112 is the width of first region 1933. W112 is typically in a range from about 1 inch to about 6 inches, and preferably from about 2 inches to about 3 inches. W114 is the width of second region 1934. In some embodiments, W114 is wider than W112. W114 is typically in a range from about 1 inch to about 6 inches, and preferably from about 2 inches to about 3 inches. In an example embodiment, the difference between W114 and W112 is typically in a range from about 0.1 inches to about 0.5 inches.

Although plate 1930 is illustrates as having two generally rectangular regions, alternative embodiments could include other shapes. For example, some embodiments taper in width from the end of second region 1934 to the opposite end of first region 1933. Various other shapes are also possible in other embodiments.

One advantage of some embodiments is that upright support extension 1900 can be connected to two different sized upright supports. In other words, two separate products do not have to be manufactured and maintained in stock. Instead, upright support extension 1900 is adjustable to mate with either sized upright support.

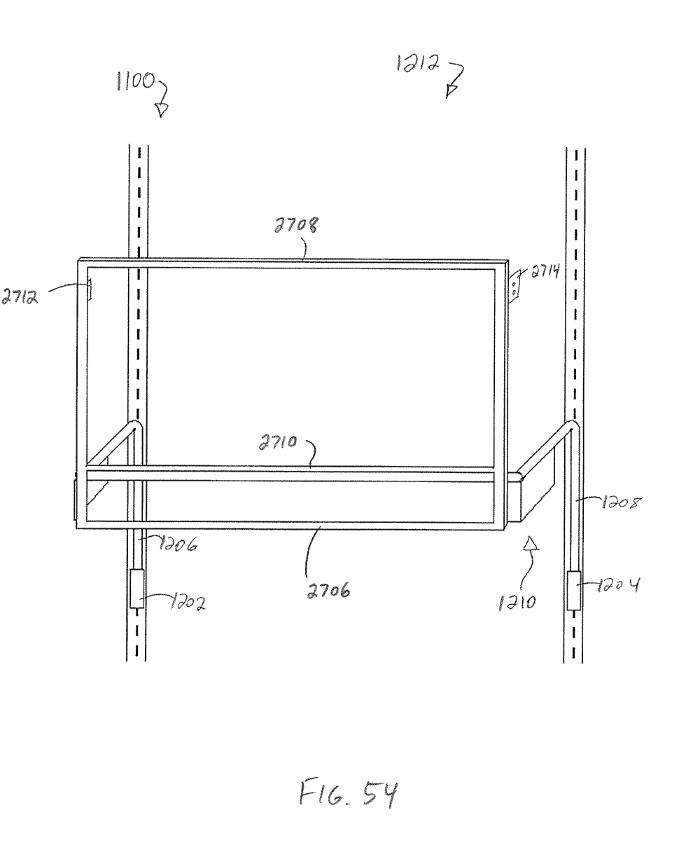

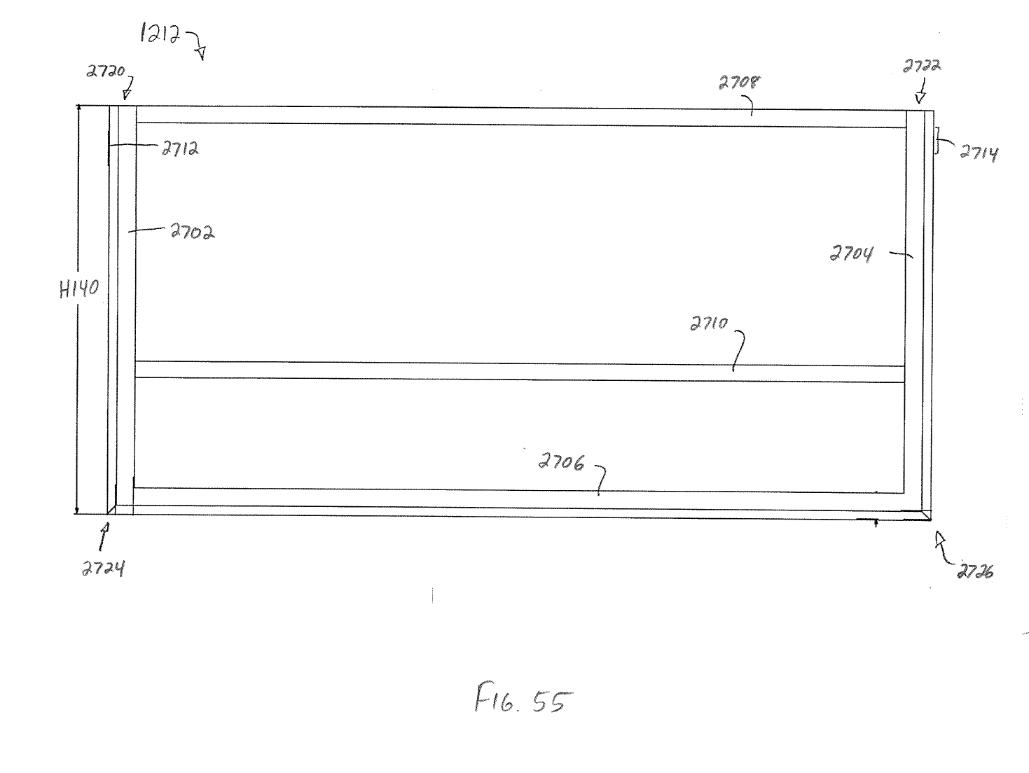

FIGS. 51-54 illustrate an example adjustable frame 1210. FIG. 51 is a perspective view of portions of elevated sign display 1200 being installed to product display system 1100. FIG. 52 is a top view of the example adjustable frame 1210. FIG. 53 is a side view of the example adjustable frame 1210. The portions of elevated sign display 1200 include adjustable upright brackets 1202 and 1204, extension arms 1206 and 1208, and adjustable frame 1210. Adjustable frame 1210 includes side support members 2402 and 2404, and horizontal support beams 2406. Horizontal support beams 2406 include beam 2410, beam 2412, and beam 2414.

Horizontal support beams 2406 extend generally horizontally. Beams 2410 and 2412 have first ends 2420 and 2422 and second ends 2424 and 2426. In one embodiment, beams 2410 and 2412 are hollow, and sized to receive the horizontal member (e.g. 1606, shown in FIG. 44) of extension arms 1206 and 1208. Beams 2410 and 2412 include a plurality of holes 2428 (FIG. 53). The plurality of holes 2428 allow beams 2410 and 2412 to engage with extension arms 1206 or 1208 at a plurality of positions. In one embodiment, spring buttons (e.g., 1702 shown in FIG. 45) of extension arms 1206 and 1208 are sized to engage with any of the plurality of holes 2428. Therefore, the position of adjustable frame 1210 is adjustable to a plurality of different depth positions, to move adjustable frame 1210 horizontally closer to or further from product display system 1100.

Beam 2414 extends between second ends 2424 and 2426 of beams 2410 and 2412. Beams 2410 and 2412 are connected to beam 2414 by welding or any other suitable fastener. In another embodiment, beams 2410 and 2412 are connected to beam 2414 by side support members 2402 and 2404. Beam 2414 includes mounting holes 2415. Beam 2414 is designed to support frame assembly 1212.

Side support members 2402 and 2404 include side members 2440 and 2442 and face members 2444 and 2446. In one embodiment, side support member 2402 and 2404 are formed of a piece of sheet metal, which is bent to form an angle of about 90 degrees between the side members 2440 and 2442 and face members 2444 and 2446. Side members 2440 and 2442 provide support to side panels 1214 and 1216 respectively.

Some example embodiments of adjustable frame 1210 include the following dimensions. W130 is the overall width of adjustable frame 1210. W130 is approximately equal to the width between slots 1108 of upright supports 1104 and 1106 (shown in FIG. 38). W130 is typically in a range from about 30 inches to about 60 inches, and preferably from about 45 inches to about 55 inches. W132 is the width of beams 2410 and 2412. W132 is typically in a range from about 0.3 inches to about 1.5 inches, and preferably from about 0.5 inches to about 1 inch. W134 is the depth of side members 2440 and 2442. W134 is typically in a range from about 4 inches to about 16 inches, and preferably from about 8 inches to about 10 inches. W136 is the distance between the centers of adjacent holes of the plurality of holes 2428. W136 is typically in a range from about 0.2 inches to about 3 inches, and preferably from about 0.5 inches to about 1.5 inches. H130 is the overall depth of adjustable frame 1210. H130 is typically in a range from about 6 inches to about 18 inches, and preferably from about 12 inches to about 14 inches. H132 is the thickness of beam 2414. H132 is typically in a range from about 0.3 inches to about 1.5 inches, and preferably from about 0.5 inches to about 1 inch.

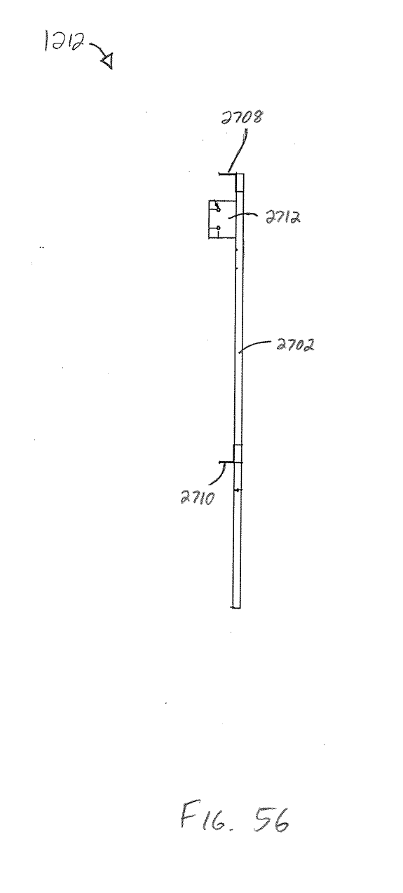

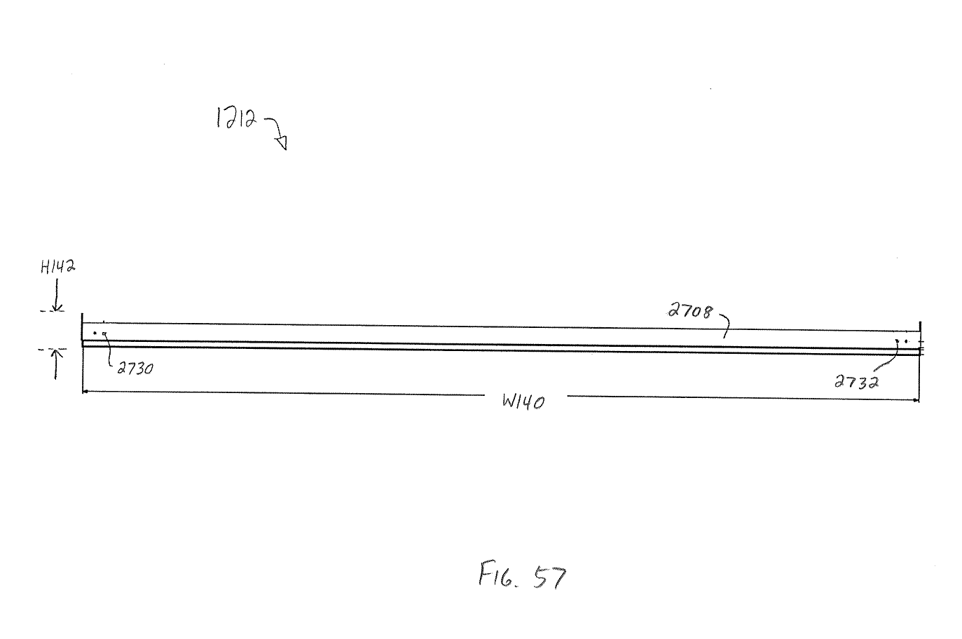

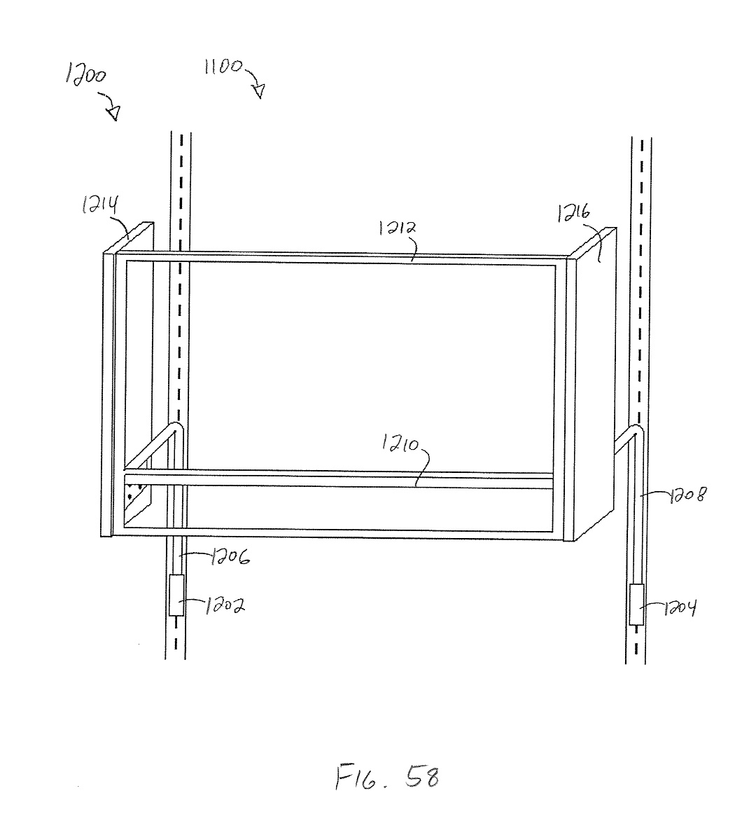

FIGS. 54-57 illustrate an example frame assembly 1212. FIG. 54 is a perspective view of portions of elevated sign display 1200 being installed to product display system 1100. FIG. 55 is a front view of the example frame assembly 1212. FIG. 56 is a left side view of the example frame assembly 1212. FIG. 57 is a top view of the example frame assembly 1212. The portions of elevated sign display 1200 include adjustable upright brackets 1202 and 1204, extension arms 1206 and 1208, adjustable frame 1210, and frame assembly 1212.

Frame assembly 1212 includes sign support members 2702, 2704, and 2706, angled brackets 2708 and 2710, and mounting tabs 2712 and 2714. Sign support members 2702 and 2704 include first ends 2720 and 2722 and second ends 2724 and 2726, respectively. Sign support members 2702, 2704, and 2706 are generally U-shaped, having an inward facing slot for receiving and supporting sign 1218. Sign support members 2702 and 2704 are connected to opposite ends of sign support member 2704 such as by welding or by any other suitable fastener. Alternatively, sign support members 2702, 2704, and 2706 are formed of a single sheet of metal and bent into the appropriate configuration.

Angled bracket 2708 is connected between the first ends 2720 and 2722 of sign support members 2702 and 2704. Angled bracket 2708 is connected to the rear sides of sign support member 2702 and 2704 so as to not interfere with insertion of a sign into first ends 2720 and 2722. Angled bracket 2710 is connected between sign support members 2702 and 2704 at a position between first ends 2720 and 2722 and second ends 2724 and 2726. Angled brackets 2708 and 2710, when properly installed, extend in a generally horizontal direction. Angled bracket 2708 provides stability to frame assembly 1212. Angled bracket 2710 also provides stability to frame assembly 1212, but also provides a location for mounting frame assembly 1212 to adjustable frame 1210. Specifically, frame assembly 1212 is mounted to adjustable frame 1210 by aligning holes in angled bracket 2710 with mounting holes 2415 of adjustable frame 1210. Fasteners are then used to mount frame assembly 1212 to adjustable frame 1210.

Mounting tabs 2712 and 2714 are connected to the sides of frame assembly 1212. Mounting tabs provide a location for mounting and supporting side panels 1214 and 1216. Angled bracket 2708 includes mounting holes 2730 and 2732 for mounting hinges 1222 and 1224, such as shown in FIG. 38, and described in more detail herein.

In some example embodiments, frame assembly 1212 includes the following dimensions. W140 is the overall width of frame assembly 1212. W140 is typically in a range from about 30 inches to about 60 inches, and preferably from about 45 inches to about 55 inches. H140 is the overall height of frame assembly 1212. H140 is typically in a range from about 6 inches to about 60 inches, and preferably from about 20 inches to about 28 inches. H142 is the overall depth of frame assembly 1212. H142 is typically in a range from about 0.3 inches to about 4 inches, and preferably from about 1 inch to about 2 inches.

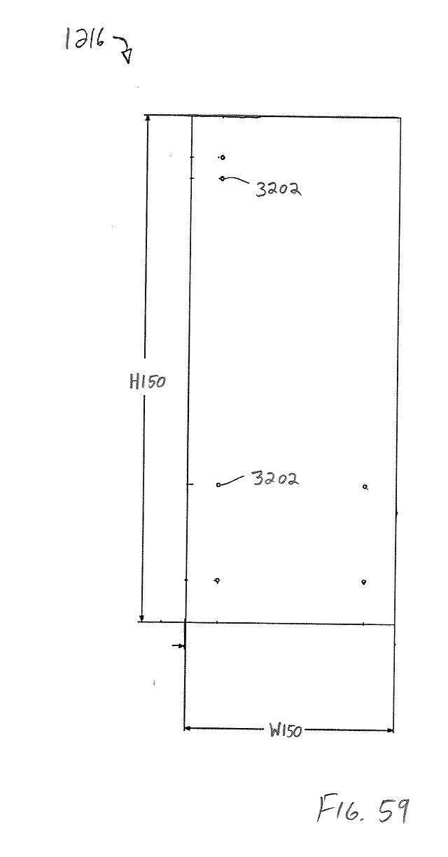

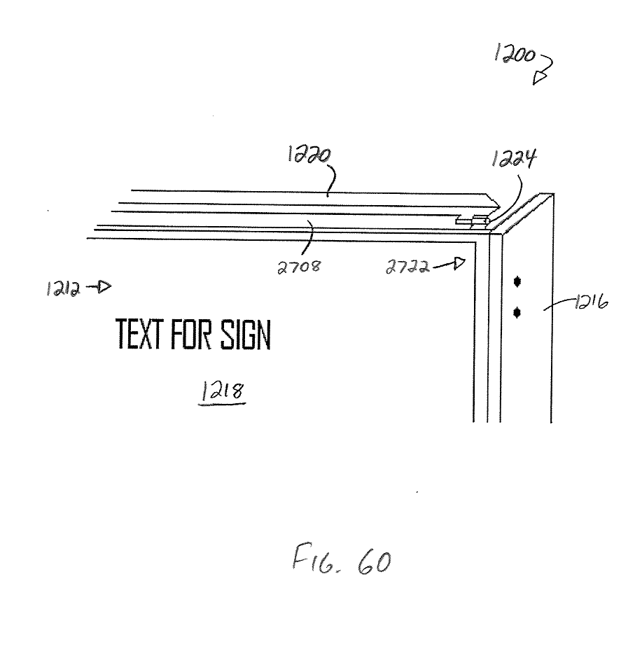

FIGS. 58-59 illustrate an example side panel 1216. FIG. 58 is a perspective view of portions of elevated sign display 1200 being installed to product display system 1100. FIG. 59 is a right side view of the example side panel 1216. The portions of elevated sign display 1200 include adjustable upright brackets 1202 and 1204, extension arms 1206 and 1208, adjustable frame 1210, frame assembly 1212, and side panels 1214 and 1216.

After installation of frame assembly 1212, side panels 1214 and 1216 are installed. To do so, fasteners are used to connect side panels 1214 and 1216 to mounting tabs 2712 and 2714 (shown in FIG. 54) and side support members 2402 and 2404 (shown in FIG. 51). Mounting holes 3202 are provided for this purpose. Alternatively, other fasteners can be used that do not require mounting holes 3202. In one embodiment, side panels 1214 and 1216 are generally rectangular panels. One of the benefits of side panels 1214 and 1216 is that they provide additional strength and stability to elevated sign display 1200. Another benefit of side panels 1214 and 1216 is that they obscure the sides of elevated sign display 1200 from view, to provide a cleaner appearance. For example, side panels 1214 and 1216 obscure at least portions of extension arms 1206 and 1208, adjustable frame 1210, and frame assembly 1212 from view. Another benefit of side panels 1214 and 1216 is that they cause elevated sign display 1200 to appear more like a box than a plate. In one possible embodiment, side panels 1214 and 1216 are made of particle board, such as having a thickness of about 0.25 inches to about 1 inch. Alternative embodiments are formed of other materials, including metal, wood, plastic, or any other desired material. Side panels 1214 and 1216 can be finished with paint, stain, or other finish. In one embodiment, a black finish is applied to side panels 1214 and 1216. In one embodiment, side panel 1216 is a mirror image of side panel 1214.

Some embodiments of side panel 1216 include the following dimensions. W150 is the overall depth of side panel 1216. W150 is typically in a range from about 2 inches to about 30 inches, and preferably from about 8 inches to about 12 inches. H150 is the overall height of side panel 1216. H150 is typically in a range from about 6 inches to about 60 inches, and preferably from about 20 inches to about 28 inches.

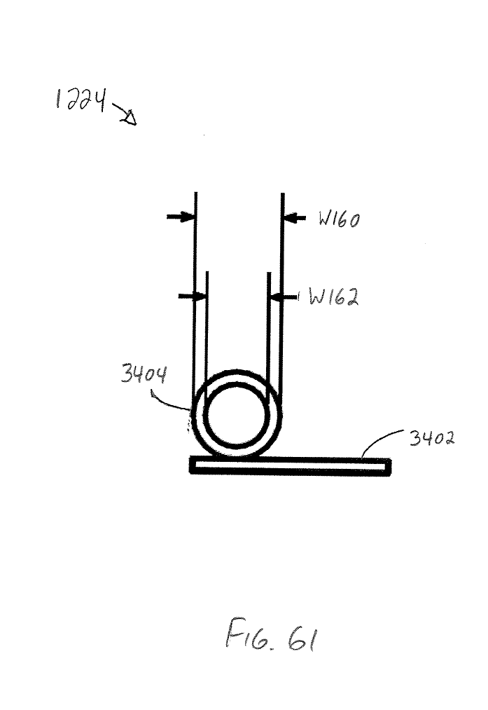

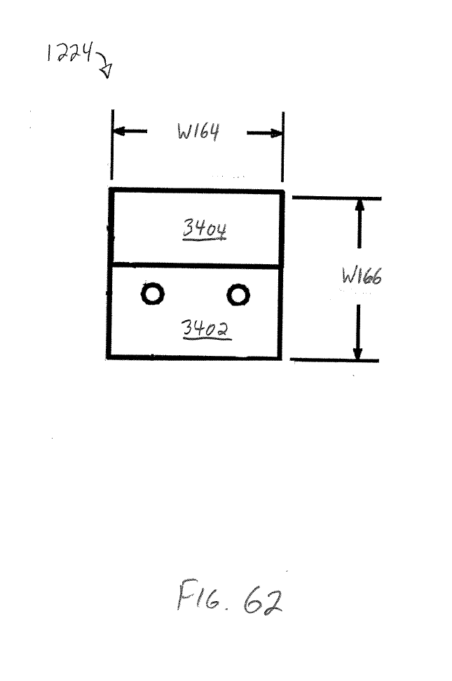

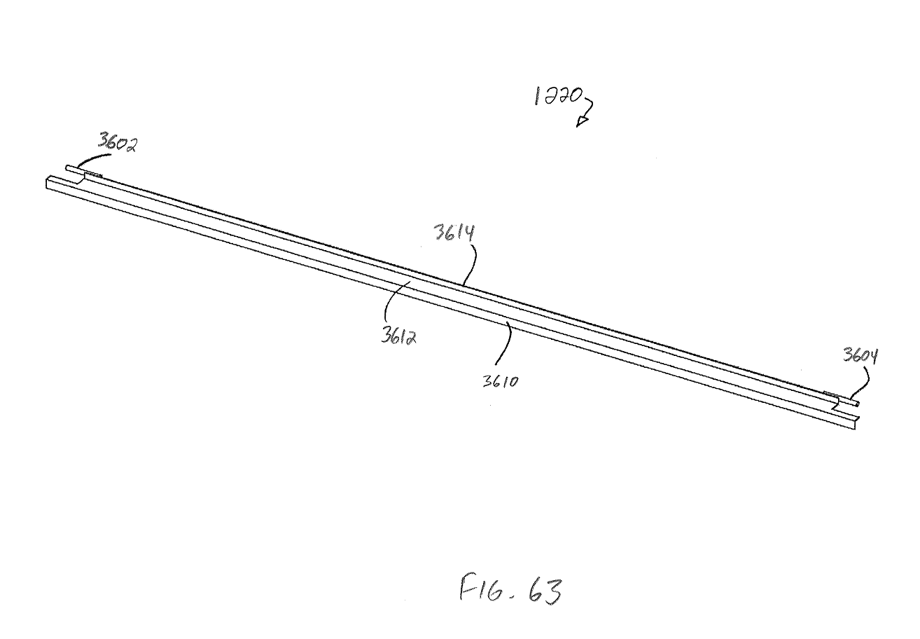

FIGS. 60-63 illustrate an example door 1220 of elevated display system 1200 including frame assembly 1212, door 1220, and hinges 1222 and 1224. FIG. 60 is a perspective view of a top right corner of elevated display system 1200. Elevated display system 1200 includes frame assembly 1212 having sign support member 2704 and angled bracket 2708. First end 2722 of sign support member 2704 is shown in FIG. 60. FIG. 61 is a left side view of hinge 1224. FIG. 62 is a top view of hinge 1224. In some embodiments, hinge 1224 is the same as hinge 1222. FIG. 63 is a perspective view of door 1220.

Door 1220 is pivotally connected to frame assembly 1212 at hinges 1222 and 1224 (shown in FIG. 38). Door 1220 is not required in all embodiments. One of the benefits of door 1220 is that it provides a cleaner appearance to elevated display system 1200, by enclosing the top side of sign 1218. Door 1220 is pivotal between a closed position (shown in FIG. 38) and an open position (shown in FIG. 60). When in the open position, first ends 2720 and 2722 of sign support members 2702 and 2704 are opened to allow sign 1218 to be inserted or removed. When in the open position, door 1220 appears to be a top portion of frame assembly 1212, obscuring the top of sign 1218 from view.

Door 1220 is connected to frame assembly 1212 by hinges 1222 and 1224. The illustrated example of hinges 1222 and 1224 include mounting plate 3402 and cylinder 3404. Mounting plate 3402 is connected to cylinder 3404 by welding. Alternatively, any other desired fastener can be used. Mounting plate 3402 includes fastener holes 2502.

Hinges 1222 and 1224 are connected to frame assembly 1212 by first aligning hinges 1222 and 1224 with holes 2730 and 2732 of angled bracket 2708. Fasteners are then used to connect hinges 1222 and 1224. Alternatively, other fasteners are used that do not require holes 2730 and 2732, such as welding or adhesive.

Some example embodiments of hinge 1224 include the following dimensions. W160 is the outer diameter of cylinder 3404. W160 is typically in a range from about 0.2 inches to about 1 inch, and preferably from about 0.3 inches to about 0.5 inches. W162 is the inner diameter of cylinder 3404. W162 is typically in a range from about 0.1 inches to about 1 inch, and preferably from about 0.2 inches to about 0.4 inches. W164 is the overall width of hinge 1224, including the width of cylinder 3404 and plate 3402. W164 is typically in a range from about 0.3 inches to about 3 inches, and preferably from about 0.5 inches to about 1 inch. W166 is the overall depth of hinge 1224. W166 is typically in a range from about 0.3 inches to about 3 inches, and preferably from about 0.5 inches to about 1.5 inches.

Prior to installing hinges to frame assembly 1212, pins 3602 and 3604, extending from opposite ends of door 1220, are inserted into hinges 1222 and 1224, respectively. Hinges 1222 and 1224 are then fastened to frame assembly 1212 to pivotally connect door 1220 to frame assembly 1212. Other known hinge designs are used in other embodiments to connect door 1220 to frame assembly 1212.

In one embodiment, door 1220 is formed of sheet metal, and includes two angled bends. Door 1220 includes a first region 3610, a second region 3612, a third region 3614, and pins 3602 and 3604. When door 1220 is in the closed position, first region 3610 is aligned generally in a plane parallel to sign 1218, such that first region 3610 extends slightly over the top edge of sign 1218. Second region 3612 is in a plane generally perpendicular to the plane of first region 3610. Third region 3614 is in a plane generally perpendicular to the plane of second region 3612, and generally parallel to the plane of first region 3610. Third region 3614 extends generally in a direction opposite from first region 3610.

Pins 3602 and 3604 are connected to opposite ends of third region 3610, such as by welding. Alternatively pins 3602 and 3604 are formed of the same piece as door 1220. Alternatively other fasteners can be used to fasten pins 3602 and 3604 to third region 3610. Alternative embodiments of door 1220 take various forms. For example, a single angled bracket could be used with a standard hinge connection.

In other example embodiments, different values for the various height, width and radius dimensions (e.g., W101-W66, H101-H150 and R101) listed herein are possible.

While certain features of the sign display system 1200 are described and shown herein as being adjustable in nature (e.g., height, length and orientation adjustable), the total width of the display system 1200 can be also be adjustable in alternative embodiments (not shown). For example, features of the adjustable frame 1210 (e.g., beams 2406) and the frame assembly 1212 (e.g., sign support member 2706 and angled brackets 2708, 2710) can be made width adjustable to permit mounting of the display system to a product display system 1100 that has variable width between upright supports 1104, 1106. Such width adjustment features can include, for example, a bracket, sleeve, or fastener. In one example, one portion of the width adjustment feature has an internal diameter greater than an external diameter of a mating portion of the width adjustment feature so that the two portions are insertable relative to each other to adjust the width dimension. Certain aspects of the sign display system 1200 can also be adjustable to accommodate various widths of the sign 1218 for a given width of the product display system 1100 between upright supports 1104, 1106.

### Conclusion

One aspect of the present disclosure relates to a sign display system arranged for connection to a product display system. The product display system includes vertically oriented upright supports, the upright supports including a face arranged in a vertical plane and having a plurality of slots formed therein. The sign display system includes first and second mounting brackets, first and second extension arms, and a sign support assembly. The first and second mounting brackets each include at least one tab insertable within the slots at connection points. The first and second extension arms each have a first end and a second end, the first end connected to the respective first or second mounting bracket, and the second end extending away from the mounting bracket at an angle. The sign support assembly is configured to support a sign, the sign support assembly supported by the first and second extension arms. The sign support assembly includes a top side and a bottom side, wherein the bottom side of the sign support assembly is positioned vertically above the connection point.

Another aspect of the present disclosure is a sign display system configured for mounting to a shelving structure, the shelving structure defining a vertical plane. The sign display system has a width dimension, a height dimension, and a depth dimension, wherein at least one of the width dimension, the height dimension, and the depth dimension is adjustable.

A further aspect of the present disclosure is a method of installing a sign display system to a product display system. The product display system includes vertically oriented upright supports, the upright supports including a face arranged in a vertical plane and having a plurality of slots defined in the face. The method comprises: connecting mounting brackets to the face of the upright supports at least one of the plurality of slots; connecting first ends of first and second extension arms to the mounting brackets, the extension arms extending away from the mounting brackets; and supporting a sign support assembly with second ends of the first and second extension arms, the sign support assembly having a top end and a bottom end, wherein the bottom end of the sign support assembly is arranged vertically above the mounting brackets.

Therefore, the sign display system includes various improvements and benefits over existing display systems. Various modifications could be made to the sign display system described herein, as will be apparent to one of skill in the art, those modifications being within the spirit and scope of the present disclosure. It is noted that all of the features characterized herein need not be incorporated within a given arrangement for the arrangement to include improvements according to the present disclosure.

What is claimed is:

1. A sign display system arranged for connection to a product display system, the product display system including vertically oriented upright supports, the upright supports including a face arranged in a vertical plane and having a plurality of slots formed therein, the sign display system comprising:
first and second mounting brackets, each mounting bracket comprising at least one tab insertable within the slots at connection points;
first and second extension arms each having a first end and a second end, the first end connected to the respective first or second mounting bracket, the second end extending away from the mounting bracket at an angle; and
a sign support assembly configured to support a sign, the sign support assembly supported by the first and second extension arms, the sign support assembly having a top side and a bottom side, wherein the bottom side of the sign support assembly is positioned vertically above the connection point.

2. The sign display system of claim 1, wherein the at least one tab of the first and second mounting brackets comprises at least two tabs arranged for connection with one of a first brand product display system or a second brand product display system, the second brand product display system having different configurations for the slots of the upright supports than the slots of the first brand product display system.

3. The sign display system of claim 1, wherein the sign support assembly includes a horizontal support beam connected between the second ends of the first and second extension arms, wherein the sign is supported by the horizontal support beam.

4. The sign display system of claim 1, wherein a portion of each of the first and second extension arms extends vertically upward and horizontally away from the upright supports, and forms an angle with upright supports in a range from about 15 degrees to about 75 degrees.

5. The sign display system of claim 1, wherein the angle is in a range from about 0 degrees to about 90 degrees relative to the vertical plane.

6. The sign display system of claim 1, wherein the angle is in a range from about 15 degrees to about 75 degrees.

7. The sign display system of claim 1, wherein a position of the sign support assembly is adjustable between a first position and a second position relative to the connection point.

8. A sign display system configured for mounting to a shelving structure, the shelving structure defining a vertical plane, the sign display system having a width dimension, a height dimension, and a depth dimension, wherein at least one of the width dimension, the height dimension, and the depth dimension is adjustable.

9. The sign display system of claim 8, further comprising a mounting bracket and an extension arm, wherein the height dimension is adjustable by moving the extension arm relative to the mounting bracket.

10. The sign display system of claim 8, further comprising an extension arm and a sign support assembly, wherein the sign support assembly includes first and second sign support members, wherein the width dimension is adjustable by moving the first sign support member relative to the second sign support member.

11. The sign display system of claim 8, further comprising an extension arm and a sign support assembly, wherein the depth dimension is adjustable by moving the sign support assembly relative to the extension arm, wherein the depth dimension is defined between the sign support assembly and the vertical plane.

12. A method of installing a sign display system to a product display system, the product display system including vertically oriented upright supports, the upright supports including a face arranged in a vertical plane and having a plurality of slots defined in the face, the method comprising:
connecting mounting brackets to the face of the upright supports at least one of the plurality of slots;
connecting first ends of first and second extension arms to the mounting brackets, the extension arms extending away from the mounting brackets; and
supporting a sign support assembly with second ends of the first and second extension arms, the sign support assembly having a top end and a bottom end, wherein the bottom end of the sign support assembly is arranged vertically above the mounting brackets.

13. The method of claim 12, further comprising selecting a type of mounting bracket that is compatible with a configuration of the plurality of slots defined in the upright supports prior to connecting the mounting brackets.

14. The method of claim 12, wherein supporting a sign support assembly further comprises:
connecting a frame of the sign support assembly to a second end of the first and second extension arms, the second end being opposite the first end.

15. The method of claim 14, further comprising adjusting a width of the frame to substantially match a width of a sign supported in the sign support member prior to connecting the frame.

16. The method of claim 12, wherein connecting the first ends of the first and second extension arms to the mounting brackets includes inserting the first ends of the first and second extension arms into one of a plurality of support tubes of each of the mounting brackets.

17. The method of claim 12, wherein connecting the first ends of the first and second extension arms to the mounting brackets includes depressing buttons at the first ends, inserting the first ends of the first and second extension arms into support tubes of each of the mounting brackets, and extending each button through one of a plurality of holes in the support tubes.

18. The method of claim 12, wherein connecting first ends of first and second extension arms to the mounting brackets comprises connecting first ends of first and second extension arms to the mounting brackets at an angle relative to the vertical plane.

19. The method of claim 18, wherein the angle is in a range from 0 degrees to 90 degrees.

20. The method of claim 18, wherein the angle is in a range from about 15 degrees to about 75 degrees.
